(19) United States
(12) Patent Application Publication
(10) Pub. No.: US 2026/0012936 A1
(43) Pub. Date: Jan. 8, 2026

(54) WIRELESS COMMUNICATION METHOD AND APPARATUS

(71) Applicant: HUAWEI TECHNOLOGIES CO., LTD., Shenzhen (CN)

(72) Inventors: Xiaohui PENG, Shenzhen (CN); Jiajin LUO, Shenzhen (CN); Baojian ZHOU, Shenzhen (CN); Ping ZHANG, Shenzhen (CN); Yang YU, Shenzhen (CN); Min YAN, Shenzhen (CN); Xun YANG, Singapore (SG)

(21) Appl. No.: 19/328,403

(22) Filed: Sep. 15, 2025

Related U.S. Application Data
(63) Continuation of application No. PCT/CN2023/082016, filed on Mar. 16, 2023.

(51) Int. Cl. H04W 72/0453; H04W 4/38; H04W 64/00

(52) U.S. Cl. CPC H04W 72/0453; H04W 4/38; H04W 64/00

(57) ABSTRACT

This application discloses a method includes: determining a first frequency domain resource, where frequency baselines formed by the first frequency domain resource meet a P-level redundancy distribution. Sending a sensing signal on the first frequency domain resource. The P-level redundancy distribution meets a first condition and a second condition. The first condition includes: The frequency baselines formed by the first frequency domain resource include a frequency baseline of a first length; and the first length is k*length of a minimum frequency baseline, k is a positive integer belonging to [1, K], K is a ratio of a length of a maximum frequency baseline to the length of the minimum frequency baseline. The second condition includes: In the frequency baselines formed by the first frequency domain resource except largest (P−1) and smallest (P−1) frequency baselines, a quantity of redundancy distribution times is greater than or equal to P.

### CROSS-REFERENCE TO RELATED APPLICATIONS

This application is a continuation of International Application No. PCT/CN2023/082016, filed on Mar. 16, 2023, the disclosure of which is hereby incorporated by reference in its entirety.

### TECHNICAL FIELD

This application relates to the field of communication technologies, and in particular, to a wireless communication method and an apparatus.

### BACKGROUND

Wireless sensing technologies are used to analyze changes of radio signals during their propagation, to capture characteristics of signal transmission space, enabling the sensing of objects or persons within an environment. For example, persons, buildings, vehicles, and the like in the environment are sensed by using the wireless sensing technologies.

Radar, which is a typical wireless sensing technology, is widely used in the fields of military affairs, agriculture, meteorology, and the like. Its fundamental principle involves transmitting a specific waveform from a transmitter, which traverses a wireless channel before being captured by a receiver. By integrating both emitted and received signals for analysis, radar extracts targets of interest within the wireless channel. A wireless communication system primarily exchanges information between a receiver and a transmitter. Its fundamental principle involves transmitting a specific waveform from a transmitter, which traverses a wireless channel before being captured by a receiver. By performing signal processing, the wireless communication system demodulates the signal transmitted by the transmitter.

Currently, there is an urgent need to address the problem of how to converge wireless communication and sensing technologies for sensing of ambient environments as well as wireless communication.

### SUMMARY

This application provides a wireless communication method and an apparatus, allowing a communication apparatus to sense its ambient environment while performing communication, thereby reducing interference caused by frequency-selective fading.

According to a first aspect, an embodiment of this application provides a wireless communication method. The method includes:

A first communication apparatus determines a first frequency domain resource, where frequency baselines formed by the first frequency domain resource meet a P-level redundancy distribution, and P is a positive integer. The first communication apparatus sends a sensing signal on the first frequency domain resource.

In this embodiment, the frequency baseline meets the P-level redundancy distribution, and when frequency-selective fading causes measurement of a part of frequency baselines to be invalidated, there is still a redundancy frequency baseline that can be covered, thereby reducing interference caused by the frequency-selective fading.

In a possible implementation, the P-level redundancy distribution meets a first condition and a second condition.

The first condition includes: The frequency baselines formed by the first frequency domain resource include a frequency baseline of a first length.

The first length is k*length of a minimum frequency baseline, k is a positive integer belonging to [1, K], K is a ratio of a length of a maximum frequency baseline to the length of the minimum frequency baseline, and K is greater than or equal to 1.

The second condition includes: In the frequency baselines formed by the first frequency domain resource except largest (P−1) and smallest (P−1) frequency baselines, a quantity of redundancy distribution times is greater than or equal to P.

In a possible implementation, a basis of setting a value of P includes: a degree of frequency-selective fading.

In this implementation, when the degree of frequency-selective fading is higher, a larger value of P is set, to obtain more redundancy to resist interference; and when the degree of frequency-selective fading is lower, a smaller value of Pis set, to save frequency domain resources.

In a possible implementation, the basis of setting the value of P includes: a frequency response amplitude difference.

In this implementation, the frequency response amplitude difference may reflect the degree of frequency-selective fading. A larger the frequency response amplitude difference indicates a higher degree of frequency-selective fading, and a smaller frequency response amplitude difference indicates a lower degree of frequency-selective fading. The frequency response amplitude difference is easier to obtain.

In a possible implementation, the frequency response amplitude difference includes at least one of the following: a ratio of a maximum value to a minimum value of a frequency response amplitude, a ratio of a variance to an average value square of the frequency response amplitude, and a ratio of a standard deviation to an amplitude response average value of the frequency response amplitude.

In this implementation, a specific representation form of the frequency response amplitude difference is provided, to help set the value of P.

In a possible implementation, the method further includes:

The first communication apparatus obtains a sensing requirement parameter. That the first communication apparatus determines the first frequency domain resource includes: The first communication apparatus determines the first frequency domain resource from a frequency domain resource pool based on the sensing requirement parameter.

In this possible implementation, a specific implementation in which the first communication apparatus determines the first frequency domain resource is provided. The first communication apparatus may obtain the sensing requirement parameter, and the first communication apparatus determines the first frequency domain resource with reference to the sensing requirement parameter. In this way, a sensing requirement can be met, and sensing performance can be improved.

In a possible implementation, that the first communication apparatus obtains the sensing requirement parameter includes: The first communication apparatus receives the sensing requirement parameter from a third communication apparatus.

In this implementation, the sensing requirement parameter may be delivered by the third communication apparatus to the first communication apparatus. The third communication apparatus may be understood as a control node, and controls the first communication apparatus to send the sensing signal.

In a possible implementation, the sensing requirement parameter includes an unambiguous ranging distance, the first frequency domain resource meets a minimum frequency baseline threshold, and the minimum frequency baseline threshold is determined based on the unambiguous ranging distance.

In a possible implementation, the sensing requirement parameter includes a ranging resolution, the first frequency domain resource meets a maximum frequency baseline threshold, and the maximum frequency baseline threshold is determined based on the ranging resolution.

In a possible implementation, the sensing requirement parameter includes sensing resource usage, the first frequency domain resource meets a maximum quantity N of frequency domain resources, and the maximum quantity N of frequency domain resources is determined based on the sensing resource usage.

In the foregoing possible implementations, a plurality of possible implementations of content specifically included in the sensing requirement parameter, and a requirement that the first frequency domain resource should meet based on these implementations are provided.

In a possible implementation, a frequency point combination includes a subcarrier combination, and the subcarrier combination is a combination including a smallest quantity of subcarriers among subcarrier combinations that meet the P-level redundancy.

In this possible implementation, there may be a plurality of subcarrier combinations that meet the P-level redundancy. In this case, the subcarrier combination may be the subcarrier combination that is with the smallest quantity of subcarriers and that is in the plurality of subcarrier combinations, to effectively save subcarrier overheads in frequency domain. This avoids that excessive communication resources are occupied and communication performance is affected.

In a possible implementation, the first frequency domain resource is a frequency domain resource set formed by extracting a part of frequency domain resources from an evenly distributed frequency domain resource set.

In this possible implementation, if the P-level redundancy distribution is met, frequency domain overheads are saved.

In a possible implementation, the first frequency domain resource includes a frequency point combination obtained by shifting a frequency point combination that meets the first condition by (0, 1, 2, . . . , P−1)*|bₘᵢₙ| respectively and then obtaining a union set. |bₘᵢₙ| is the minimum frequency baseline.

In a possible implementation, the first frequency domain resource includes: {1, 2, . . . , N1+P, 2*(N1+1), 2*(N1+1)+1, . . . , 2*(N1+1)+P−1, . . . , N2*(N1+1), N2*(N1+1)+1, . . . , N2*(N1+1)+P−1}*|bₘᵢₙ|. |bₘᵢₙ| is the minimum frequency baseline, and N1 and N2 are positive integers.

In the foregoing possible implementations, the first frequency domain resource can be conveniently and quickly constructed.

In a possible implementation, N1, N2, and P satisfy N2*(N1+1)+P−1≥|bₘₐₓ|/|bₘᵢₙ|, and | bₘₐₓ| is the maximum frequency baseline.

In a possible implementation, N1, N2, and P satisfy N≥N1+P*N2, and N is the maximum quantity of frequency domain resources.

In the foregoing possible implementations, constraints of parameters are provided, to help set values of the parameters properly.

In a possible implementation, P is a largest value that meets a constraint.

In this possible implementation, a largest quantity of redundancy can be obtained, and interference can be avoided to a greater extent.

In a possible implementation, the method further includes: The first communication apparatus sends first information to a second communication apparatus, where the first information indicates a frequency domain position of the first frequency domain resource.

In this possible implementation, the first communication apparatus indicates the frequency domain position of the first frequency domain resource to the second communication apparatus. In this way, the second communication apparatus may receive the sensing signal on the frequency domain resource of the first frequency domain resource, to sense and measure an ambient environment.

In a possible implementation, the first information includes a frequency domain resource construction parameter, and the frequency domain resource construction parameter is used to construct the first frequency domain resource; the first information includes the frequency domain position of the first frequency domain resource; or the first information includes a sensing quality index, and the sensing quality index indicates the frequency domain position of the first frequency domain resource.

In this possible implementation, three specific implementations in which the first information indicates the frequency domain position of the first frequency domain resource are provided. Specifically, the first information may directly indicate the frequency domain position of the first frequency domain resource, and an indication manner is simple. Alternatively, the first information indirectly indicates the frequency domain position of the first frequency domain resource by using the index. In this indication manner, a smaller quantity of indication bits is needed, so that indication bit overheads can be saved. Alternatively, the first information indirectly indicates the frequency domain position of the first frequency domain resource by using the frequency domain resource construction parameter, so that indication bit overheads can be saved, and this indication manner is more flexible.

In another possible implementation, the first information is carried in radio resource control (RRC) signaling or downlink control information DCI (downlink control information) signaling.

In this possible implementation, two types of possible signaling that carries the first information are provided, to provide a basis for embodiments of solutions.

In a possible implementation, the method further includes: The first communication apparatus sends trigger signaling to the second communication apparatus, where the trigger signaling is used to trigger the second communication apparatus to enable a sensing function.

In this possible implementation, a trigger condition for enabling the sensing function by the second communication apparatus is provided, to provide a basis for embodiments of solutions.

In a possible implementation, types of the trigger signaling include the RRC signaling or the DCI signaling.

In this implementation, the second communication apparatus may be triggered, by using the RRC signaling or the DCI signaling, to enable the sensing function.

In a possible implementation, the frequency domain resource pool includes a frequency domain resource used for transmission of a channel state information reference signal between the first communication apparatus and the second communication apparatus. Alternatively, the frequency domain resource pool includes a frequency domain resource used for transmission of communication data between the first communication apparatus and the second communication apparatus.

In this possible implementation, two possible communication resources included in the frequency domain resource pool are provided, and may be used to select the first frequency domain resource, so that a communication apparatus senses an ambient environment while performing communication.

According to a second aspect, an embodiment of this application provides a wireless communication method. The method includes:

A second communication apparatus determines a first frequency domain resource, where frequency baselines formed by the first frequency domain resource meet a P-level redundancy distribution, and Pis a positive integer. The second communication apparatus receives a sensing signal from the first communication apparatus on the first frequency domain resource.

In a possible implementation, the method further includes: The second communication apparatus senses and measures the sensing signal, to obtain a sensing result.

In this embodiment, the frequency baseline meets the P-level redundancy distribution, and when frequency-selective fading causes measurement of a part of frequency baselines to be invalidated, there is still a redundancy frequency baseline that can be covered, thereby reducing interference caused by the frequency-selective fading.

In a possible implementation, the P-level redundancy distribution meets a first condition and a second condition.

The first condition includes: The frequency baselines formed by the first frequency domain resource include a frequency baseline of a first length.

The first length is k*length of a minimum frequency baseline, k is a positive integer belonging to [1, K], K is a ratio of a length of a maximum frequency baseline to the length of the minimum frequency baseline, and K is greater than or equal to 1.

The second condition includes: In the frequency baselines formed by the first frequency domain resource except largest (P−1) and smallest (P−1) frequency baselines, a quantity of redundancy distribution times is greater than or equal to P.

In a possible implementation, a basis of setting a value of P includes: a degree of frequency-selective fading.

In this implementation, when the degree of frequency-selective fading is higher, a larger value of P is set, to obtain more redundancy to resist interference; and when the degree of frequency-selective fading is lower, a smaller value of Pis set, to save frequency domain resources.

In a possible implementation, the basis of setting the value of P includes: a frequency response amplitude difference.

In this implementation, the frequency response amplitude difference may reflect the degree of frequency-selective fading. A larger the frequency response amplitude difference indicates a higher degree of frequency-selective fading, and a smaller frequency response amplitude difference indicates a lower degree of frequency-selective fading. The frequency response amplitude difference is easier to obtain.

In a possible implementation, the frequency response amplitude difference includes at least one of the following: a ratio of a maximum value to a minimum value of a frequency response amplitude, a ratio of a variance to an average value square of the frequency response amplitude, and a ratio of a standard deviation to an amplitude response average value of the frequency response amplitude.

In this implementation, a specific representation form of the frequency response amplitude difference is provided, to help set the value of P.

In a possible implementation, the method further includes:

The second communication apparatus obtains a sensing requirement parameter. That the second communication apparatus determines the first frequency domain resource includes: The second communication apparatus determines the first frequency domain resource from the frequency domain resource pool based on the sensing requirement parameter.

In this possible implementation, a specific implementation in which the second communication apparatus determines the first frequency domain resource is provided. The second communication apparatus may obtain the sensing requirement parameter, and the second communication apparatus determines the first frequency domain resource with reference to the sensing requirement parameter. In this way, a sensing requirement can be met, and sensing performance can be improved.

In a possible implementation, that the second communication apparatus obtains the sensing requirement parameter includes: The second communication apparatus receives the sensing requirement parameter from a third communication apparatus.

In this implementation, the sensing requirement parameter may be delivered by the third communication apparatus to the second communication apparatus. The third communication apparatus may be understood as a control node, and controls the second communication apparatus to send the sensing signal.

In a possible implementation, the sensing requirement parameter includes an unambiguous ranging distance, the first frequency domain resource meets a minimum frequency baseline threshold, and the minimum frequency baseline threshold is determined based on the unambiguous ranging distance.

In a possible implementation, the sensing requirement parameter includes a ranging resolution, the first frequency domain resource meets a maximum frequency baseline threshold, and the maximum frequency baseline threshold is determined based on the ranging resolution.

In a possible implementation, the sensing requirement parameter includes sensing resource usage, the first frequency domain resource meets a maximum quantity N of frequency domain resources, and the maximum quantity N of frequency domain resources is determined based on the sensing resource usage.

In the foregoing possible implementations, a plurality of possible implementations of content specifically included in the sensing requirement parameter, and a requirement that the first frequency domain resource should meet based on these implementations are provided.

In a possible implementation, a frequency point combination includes a subcarrier combination, and the subcarrier combination is a combination including a smallest quantity of subcarriers among subcarrier combinations that meet the P-level redundancy.

In this possible implementation, there may be a plurality of subcarrier combinations that meet the P-level redundancy. In this case, the subcarrier combination may be the subcarrier combination that is with the smallest quantity of subcarriers and that is in the plurality of subcarrier combinations, to effectively save subcarrier overheads in frequency domain. This avoids that excessive communication resources are occupied and communication performance is affected.

In a possible implementation, the first frequency domain resource is a frequency domain resource set formed by extracting a part of frequency domain resources from an evenly distributed frequency domain resource set.

In this possible implementation, if the P-level redundancy distribution is met, frequency domain overheads are saved.

In a possible implementation, the first frequency domain resource includes a frequency point combination obtained by shifting a frequency point combination that meets the first condition by (0, 1, 2, . . . , P−1)*|bₘᵢₙ| respectively and then obtaining a union set. |bₘᵢₙ| is the minimum frequency baseline.

In a possible implementation, the first frequency domain resource includes: {1, 2, . . . , N1+P, 2*(N1+1), 2*(N1+1)+1, . . . , 2*(N1+1)+P−1, . . . , N2*(N1+1), N2*(N1+1)+1, . . . . , N2*(N1+1)+P−1}*|bₘᵢₙ|. |bₘᵢₙ| is the minimum frequency baseline, and N1 and N2 are positive integers.

In the foregoing possible implementations, the first frequency domain resource can be conveniently and quickly constructed.

In a possible implementation, N1, N2, and P satisfy N2*(N1+1)+P−1≥|bₘₐₓ|/|bₘᵢₙ|, and |bₘₐₓ| is the maximum frequency baseline.

In a possible implementation, N1, N2, and P satisfy N≥N1+P*N2, and N is the maximum quantity of frequency domain resources.

In the foregoing possible implementations, constraints of parameters are provided, to help set values of the parameters properly.

In a possible implementation, P is a largest value that meets a constraint.

In this possible implementation, a largest quantity of redundancy can be obtained, and interference can be avoided to a greater extent.

In a possible implementation, the method further includes: The second communication apparatus receives first information from the first communication apparatus, where the first information indicates a frequency domain position of the first frequency domain resource.

In this possible implementation, the second communication apparatus receives the frequency domain position that is of the first frequency domain resource and that is indicated by the first communication apparatus. In this way, the second communication apparatus may receive the sensing signal on the frequency domain resource of the first frequency domain resource, to sense and measure an ambient environment.

In a possible implementation, the first information includes a frequency domain resource construction parameter, and the frequency domain resource construction parameter is used to construct the first frequency domain resource; the first information includes the frequency domain position of the first frequency domain resource; or the first information includes a sensing quality index, and the sensing quality index indicates the frequency domain position of the first frequency domain resource.

In this possible implementation, three specific implementations in which the first information indicates the frequency domain position of the first frequency domain resource are provided. Specifically, the first information may directly indicate the frequency domain position of the first frequency domain resource, and an indication manner is simple. Alternatively, the first information indirectly indicates the frequency domain position of the first frequency domain resource by using the index. In this indication manner, a smaller quantity of indication bits is needed, so that indication bit overheads can be saved. Alternatively, the first information indirectly indicates the frequency domain position of the first frequency domain resource by using the frequency domain resource construction parameter, so that indication bit overheads can be saved, and this indication manner is more flexible.

In another possible implementation, the first information is carried in radio resource control (RRC) signaling or downlink control information DCI (downlink control information) signaling.

In this possible implementation, two types of possible signaling that carries the first information are provided, to provide a basis for embodiments of solutions.

In a possible implementation, the method further includes: The second communication apparatus receives trigger signaling from the first communication apparatus, where the trigger signaling is used to trigger the second communication apparatus to enable a sensing function.

In this possible implementation, a trigger condition for enabling the sensing function by the second communication apparatus is provided, to provide a basis for embodiments of solutions.

In a possible implementation, types of the trigger signaling include the RRC signaling or the DCI signaling.

In this implementation, the second communication apparatus may be triggered, by using the RRC signaling or the DCI signaling, to enable the sensing function.

In a possible implementation, the frequency domain resource pool includes a frequency domain resource used for transmission of a channel state information reference signal between the first communication apparatus and the second communication apparatus.

Alternatively, the frequency domain resource pool includes a frequency domain resource used for transmission of communication data between the first communication apparatus and the second communication apparatus.

In this possible implementation, two possible communication resources included in the frequency domain resource pool are provided, and may be used to select the first frequency domain resource, so that a communication apparatus senses an ambient environment while performing communication.

According to a third aspect, an embodiment of this application provides a wireless communication apparatus. A first communication apparatus includes:
a processing module, configured to determine a first frequency domain resource, where frequency baselines formed by the first frequency domain resource meet a P-level redundancy distribution, and P is a positive integer; and
a transceiver module, configured to send the sensing signal on the first frequency domain resource.

In a possible implementation, the P-level redundancy distribution meets a first condition and a second condition.

The first condition includes: The frequency baselines formed by the first frequency domain resource include a frequency baseline of a first length.

The first length is k*length of a minimum frequency baseline, k is a positive integer belonging to [1, K], K is a ratio of a length of a maximum frequency baseline to the length of the minimum frequency baseline, and K is greater than or equal to 1.

The second condition includes: In the frequency baselines formed by the first frequency domain resource except largest (P−1) and smallest (P−1) frequency baselines, a quantity of redundancy distribution times is greater than or equal to P.

In a possible implementation, a basis of setting a value of P includes: a degree of frequency-selective fading.

In a possible implementation, the basis of setting the value of P includes: a frequency response amplitude difference.

In a possible implementation, the frequency response amplitude difference includes at least one of the following: a ratio of a maximum value to a minimum value of a frequency response amplitude, a ratio of a variance to an average value square of the frequency response amplitude, and a ratio of a standard deviation to an amplitude response average value of the frequency response amplitude.

In a possible implementation, the transceiver module is further configured to:
obtain a sensing requirement parameter.

The processing module is specifically configured to:
determine the first frequency domain resource from the frequency domain resource pool based on the sensing requirement parameter.

In a possible implementation, the transceiver module is specifically configured to receive the sensing requirement parameter from a third communication apparatus.

In a possible implementation, the sensing requirement parameter includes an unambiguous ranging distance, the first frequency domain resource meets a minimum frequency baseline threshold, and the minimum frequency baseline threshold is determined based on the unambiguous ranging distance.

In a possible implementation, the sensing requirement parameter includes a ranging resolution, the first frequency domain resource meets a maximum frequency baseline threshold, and the maximum frequency baseline threshold is determined based on the ranging resolution.

In a possible implementation, the sensing requirement parameter includes sensing resource usage, the first frequency domain resource meets a maximum quantity N of frequency domain resources, and the maximum quantity N of frequency domain resources is determined based on the sensing resource usage.

In a possible implementation, a frequency point combination includes a subcarrier combination, and the subcarrier combination is a combination including a smallest quantity of subcarriers among subcarrier combinations that meet the P-level redundancy.

In a possible implementation, the first frequency domain resource is a frequency domain resource set formed by extracting a part of frequency domain resources from an evenly distributed frequency domain resource set.

In a possible implementation, the first frequency domain resource includes a frequency point combination obtained by shifting a frequency point combination that meets the first condition by (0, 1, 2, . . . , P−1)*|bₘᵢₙ| respectively and then obtaining a union set. |bₘᵢₙ| is the minimum frequency baseline.

In a possible implementation, the first frequency domain resource includes: {1, 2, . . . , N1+P, 2*(N1+1), 2*(N1+1)+1, . . . , 2*(N1+1)+P−1, . . . , N2*(N1+1), N2*(N1+1)+1, . . . , N2*(N1+1)+P−1}*|bₘᵢₙ|. |bₘᵢₙ| is the minimum frequency baseline, and N1 and N2 are positive integers.

In a possible implementation, N1, N2, and P satisfy N2*(N1+1)+P−1≥|bₘₐₓ\/\bₘᵢₙ|, and |bₘₐₓ| is the maximum frequency baseline.

In a possible implementation, N1, N2, and P satisfy N≥N1+P*N2, and N is the maximum quantity of frequency domain resources.

In a possible implementation, P is a largest value that meets a constraint.

In this possible implementation, a largest quantity of redundancy can be obtained, and interference can be avoided to a greater extent.

In a possible implementation, the transceiver module is further configured to send first information to a second communication apparatus, where the first information indicates a frequency domain position of the first frequency domain resource.

In a possible implementation, the first information includes a frequency domain resource construction parameter, and the frequency domain resource construction parameter is used to construct the first frequency domain resource; the first information includes the frequency domain position of the first frequency domain resource; or the first information includes a sensing quality index, and the sensing quality index indicates the frequency domain position of the first frequency domain resource.

In another possible implementation, the first information is carried in radio resource control (RRC) signaling or downlink control information DCI (downlink control information) signaling.

In a possible implementation, the transceiver module is further configured to send trigger signaling to the second communication apparatus, where the trigger signaling is used to trigger the second communication apparatus to enable a sensing function.

In a possible implementation, types of the trigger signaling include the RRC signaling or the DCI signaling.

In a possible implementation, the frequency domain resource pool includes a frequency domain resource used for transmission of a channel state information reference signal between the first communication apparatus and the second communication apparatus. Alternatively, the frequency domain resource pool includes a frequency domain resource used for transmission of communication data between the first communication apparatus and the second communication apparatus.

For beneficial effects of the communication apparatus provided in the third aspect and the possible implementations of the third aspect, refer to beneficial effect achieved by the first aspect and the possible implementations of the first aspect. Details are not described herein again.

According to a fourth aspect, an embodiment of this application provides a wireless communication apparatus. A second communication apparatus includes:

a processing module, configured to determine a first frequency domain resource, where frequency baselines formed by the first frequency domain resource meet a P-level redundancy distribution, and P is a positive integer; and a transceiver module, configured to receive a sensing signal from a first communication apparatus on the first frequency domain resource.

In a possible implementation, the processing module is further configured to: sense and measure the sensing signal, to obtain a sensing result.

In a possible implementation, the P-level redundancy distribution meets a first condition and a second condition.

The first condition includes: The frequency baselines formed by the first frequency domain resource include a frequency baseline of a first length.

The first length is k*length of a minimum frequency baseline, k is a positive integer belonging to [1, K], K is a ratio of a length of a maximum frequency baseline to the length of the minimum frequency baseline, and K is greater than or equal to 1.

The second condition includes: In the frequency baselines formed by the first frequency domain resource except largest (P−1) and smallest (P−1) frequency baselines, a quantity of redundancy distribution times is greater than or equal to P.

In a possible implementation, a basis of setting a value of P includes: a degree of frequency-selective fading.

In a possible implementation, the basis of setting the value of P includes: a frequency response amplitude difference.

In a possible implementation, the frequency response amplitude difference includes at least one of the following: a ratio of a maximum value to a minimum value of a frequency response amplitude, a ratio of a variance to an average value square of the frequency response amplitude, and a ratio of a standard deviation to an amplitude response average value of the frequency response amplitude.

In a possible implementation, the transceiver module is further configured to:
obtain a sensing requirement parameter.

The processing module is specifically configured to:
determine the first frequency domain resource from the frequency domain resource pool based on the sensing requirement parameter.

In a possible implementation, the transceiver module is specifically configured to receive the sensing requirement parameter from a third communication apparatus.

In a possible implementation, the sensing requirement parameter includes an unambiguous ranging distance, the first frequency domain resource meets a minimum frequency baseline threshold, and the minimum frequency baseline threshold is determined based on the unambiguous ranging distance.

In a possible implementation, the sensing requirement parameter includes a ranging resolution, the first frequency domain resource meets a maximum frequency baseline threshold, and the maximum frequency baseline threshold is determined based on the ranging resolution.

In a possible implementation, the sensing requirement parameter includes sensing resource usage, the first frequency domain resource meets a maximum quantity N of frequency domain resources, and the maximum quantity N of frequency domain resources is determined based on the sensing resource usage.

In a possible implementation, a frequency point combination includes a subcarrier combination, and the subcarrier combination is a combination including a smallest quantity of subcarriers among subcarrier combinations that meet the P-level redundancy.

In a possible implementation, the first frequency domain resource is a frequency domain resource set formed by extracting a part of frequency domain resources from an evenly distributed frequency domain resource set.

In a possible implementation, the first frequency domain resource includes a frequency point combination obtained by shifting a frequency point combination that meets the first condition by (0, 1, 2, . . . , P−1)*|bₘᵢₙ| respectively and then obtaining a union set. |bₘᵢₙ| is the minimum frequency baseline.

In a possible implementation, the first frequency domain resource includes: {1, 2, . . . , N1+P, 2*(N1+1), 2*(N1+1)+1, . . . , 2*(N1+1)+P−1, . . . , N2*(N1+1), N2*(N1+1)+1, . . . , N2*(N1+1)+P−1}*|bₘᵢₙ|. |bₘᵢₙ| is the minimum frequency baseline, and N1 and N2 are positive integers.

In a possible implementation, N1, N2, and P satisfy N2*(N1+1)+P−1≥|bₘₐₓ|/|bₘᵢₙ|, and | bₘₐₓ| is the maximum frequency baseline.

In a possible implementation, N1, N2, and P satisfy N≥N1+P*N2, and N is the maximum quantity of frequency domain resources.

In a possible implementation, P is a largest value that meets a constraint.

In this possible implementation, a largest quantity of redundancy can be obtained, and interference can be avoided to a greater extent.

In a possible implementation, the transceiver module is further configured to receive first information from the first communication apparatus, where the first information indicates a frequency domain position of the first frequency domain resource.

In a possible implementation, the first information includes a frequency domain resource construction parameter, and the frequency domain resource construction parameter is used to construct the first frequency domain resource; the first information includes the frequency domain position of the first frequency domain resource; or the first information includes a sensing quality index, and the sensing quality index indicates the frequency domain position of the first frequency domain resource.

In another possible implementation, the first information is carried in radio resource control (RRC) signaling or downlink control information DCI (downlink control information) signaling.

In a possible implementation, the transceiver module is further configured to receive trigger signaling sent by the first communication apparatus, where the trigger signaling is used to trigger the second communication apparatus to enable a sensing function.

In a possible implementation, types of the trigger signaling include the RRC signaling or the DCI signaling.

In a possible implementation, the frequency domain resource pool includes a frequency domain resource used for transmission of a channel state information reference signal between the first communication apparatus and the second communication apparatus. Alternatively, the frequency domain resource pool includes a frequency domain resource used for transmission of communication data between the first communication apparatus and the second communication apparatus.

For beneficial effects of the communication apparatus provided in the fourth aspect and the possible implementations of the fourth aspect, refer to the beneficial effects achieved by the second aspect and the possible implementations of the second aspect. Details are not described herein again.

According to a fifth aspect, an embodiment of this application provides a communication apparatus, including: a processor, configured to perform the method in the first aspect, the second aspect, or the possible implementations by running a computer program or by using a logic circuit.

In a possible implementation, the communication apparatus further includes a memory, where the memory is configured to store the computer program.

In a possible implementation, the communication apparatus further includes a communication interface, where the communication interface is configured to input and/or output a signal.

According to a sixth aspect, an embodiment of this application provides a communication system, including: a first communication apparatus configured to perform the method in the first aspect or the possible implementations, and a second communication apparatus configured to perform the method in the second aspect or the possible implementations.

According to a seventh aspect, an embodiment of this application provides a computer-readable storage medium, configured to store computer program instructions. The computer program causes a computer to perform the method in the first aspect, the second aspect, or the possible implementations.

According to an eighth aspect, an embodiment of this application provides a computer program product, including computer program instructions. The computer program instructions cause a computer to perform the method in the first aspect, the second aspect, or the possible implementations.

According to a ninth aspect, an embodiment of this application provides a computer program. The computer program causes a computer to perform the method in the first aspect, the second aspect, or the possible implementations.

### BRIEF DESCRIPTION OF DRAWINGS

FIG. 1A is a diagram of an application scenario according to an embodiment of this application;

FIG. 1B is a diagram of another application scenario according to an embodiment of this application;

FIG. 1C is a diagram of another application scenario according to an embodiment of this application;

FIG. 1D is a diagram of another application scenario according to an embodiment of this application;

FIG. 1E is a diagram of another application scenario according to an embodiment of this application;

FIG. 1F is a diagram of another application scenario according to an embodiment of this application;

FIG. 2A is a schematic flowchart of a communication method according to an embodiment of this application;

FIG. 2B is a diagram of another application scenario according to an embodiment of this application;

FIG. 2C is another schematic flowchart of a communication method according to an embodiment of this application;

FIG. 2D is another schematic flowchart of a communication method according to an embodiment of this application;

FIG. 2E is another schematic flowchart of a communication method according to an embodiment of this application;

FIG. 3 is another schematic flowchart of a communication method according to an embodiment of this application;

FIG. 4 is another schematic flowchart of a communication method according to an embodiment of this application;

FIG. 5 is another schematic flowchart of a communication method according to an embodiment of this application;

FIG. 6A is a diagram of a frequency point combination according to an embodiment of this application;

FIG. 6B is a diagram of frequency baselines formed by a frequency point combination and redundancy amounts of the frequency baselines formed by the frequency point combination according to an embodiment of this application;

FIG. 7A is another diagram of a frequency point combination according to an embodiment of this application;

FIG. 7B is another diagram of frequency baselines formed by a frequency point combination and redundancy amounts of the frequency baselines formed by the frequency point combination according to an embodiment of this application;

FIG. 8 is a diagram of a structure of a first communication apparatus according to an embodiment of this application;

FIG. 9 is a diagram of a structure of a second communication apparatus according to an embodiment of this application;

FIG. 10 is a diagram of another structure of a first communication apparatus according to an embodiment of this application;

FIG. 11 is a diagram of another structure of a second communication apparatus according to an embodiment of this application; and

FIG. 12 is a diagram of a structure of a terminal device according to an embodiment of this application; and

FIG. 13 is a diagram of a communication system according to an embodiment of this application.

### DESCRIPTION OF EMBODIMENTS

Embodiments of this application provide a communication method and an apparatus, so that a communication apparatus senses an ambient environment while performing communication, and interference caused by frequency-selective fading can be reduced.

The following clearly and describes technical solutions in embodiments of this application with reference to accompanying drawings in embodiments of this application. It is clear that described embodiments are merely some but not all of embodiments of this application. All other embodiments obtained by a person skilled in the art based on embodiments of this application without creative efforts shall fall within the protection scope of this application.

Reference to “an embodiment”, “some embodiments”, or the like described in this specification means that one or more embodiments of this application include a specific feature, structure, or characteristic described with reference to embodiments. Therefore, statements such as “in one embodiment”, “in some embodiments”, “in some other embodiments”, and “in other embodiments” that appear at different places in this specification do not necessarily mean referring to a same embodiment. Instead, the statements mean “one or more but not all of embodiments”, unless otherwise specifically emphasized in another manner. Terms “include”, “comprise”, “have”, and their variants all mean “include but are not limited to”, unless otherwise specifically emphasized in another manner.

In this application, “at least one” means one or more, and “a plurality of” means two or more than two. “And/or” is an association relationship for describing associated objects and indicates that three relationships may exist. For example, A and/or B may indicate the following three cases: Only A exists, both A and B exist, and only B exists. A and B may be singular or plural. “At least one of the following items (pieces)” or a similar expression thereof means any combination of these items, including a single item (piece) or any combination of a plurality of items (pieces). For example, at least one item (piece) of a, b, or c may indicate a, b, c, a and b, a and c, b and c, or a, b, and c, where a, b, and c may be singular or plural.

A communication system to which the technical solutions of this application are applicable includes but is not limited to a long term evolution (LTE) system, a 5th-generation (5G) communication mobile communication system, a mobile communication system (for example, a 6G mobile communication system) after a 5G network, a device to device (D2D) communication system, or a vehicle to everything (V2X) communication system.

In embodiments of this application, the communication system includes a first communication apparatus. The first communication apparatus sends a sensing signal while performing communication, to sense an ambient environment.

In a possible implementation, the first communication apparatus is a communication apparatus that has both a sensing capability and a communication capability. The first communication apparatus determines a first frequency domain resource, and sends the sensing signal on the first frequency domain resource. The sensing signal is reflected to the first communication apparatus through a sensed target in the ambient environment, and the first communication apparatus receives the sensing signal reflected through the sensed target. In this way, the first communication apparatus may sense and measure the sensing signal, to obtain a sensing result. For example, the first communication apparatus determines a distance between the sensed target and the first communication apparatus, and the like.

In another possible implementation, the communication system further includes a second communication apparatus. The first communication apparatus determines a first frequency domain resource, and sends the sensing signal on the first frequency domain resource. The sensing signal is reflected back through a sensed target in the ambient environment, and the second communication apparatus receives the sensing signal reflected through the sensed target. Then, the second communication apparatus senses and measures the sensing signal, to obtain a sensing result. For example, the first communication apparatus determines a distance between the sensed target and the first communication apparatus, and the like.

In this implementation, optionally, the communication system further includes a third communication apparatus. The third communication apparatus may notify the first communication apparatus to send the sensing signal. The third communication apparatus may notify the second communication apparatus to enable a sensing function.

In the foregoing two possible implementations, a frequency domain resource pool may include a frequency domain resource for communication and a frequency domain resource for positioning. This is not specifically limited in this application. The first frequency domain resource is a frequency domain resource selected from the frequency domain resource pool.

In embodiments of this application, the first communication apparatus and the second communication apparatus may be radar devices, vehicle-mounted devices, network devices, terminal devices, or the like. The third communication apparatus is a network device.

The network device is an apparatus that is deployed in a radio access network and that provides a wireless communication function for a terminal device. The network device may be a base station, and the base station includes a macro base station, a micro base station, a relay station, and an access network point in various forms. For example, the base station in embodiments of this application may be a base station in new radio (NR), a transmission reception point (TRP), a transmission point (TP), or a next-generation NodeB (ngNB), or may be an evolved NodeB (eNB, or eNodeB) in a long term evolution (LTE) system.

The terminal device may be a device that provides voice or data connectivity for a user. The terminal device is also referred to as user equipment (UE), or may be referred to as a mobile station, a subscriber unit (subscriber unit), a station, terminal equipment (TE), or the like. The terminal device may be a cellular phone, a personal digital assistant (PDA), a wireless modem, a handheld device, a laptop computer, a cordless phone, a wireless local loop (WLL) station, a tablet computer, a vehicle-mounted device, a wearable device, a computing device, an uncrewed aerial vehicle, or the like. With development of wireless communication technologies, a device that can access a communication system, can communicate with a network side of a communication system, or can communicate with another object by using a communication system may be the terminal device in embodiments of this application, for example, a terminal device and a vehicle in smart transportation, a household device in a smart household, an electricity meter reading instrument, a voltage monitoring instrument, an environment monitoring instrument, and the like in a smart grid, a video surveillance instrument, a cash register, and the like in an intelligent security network.

The following shows some application scenarios to which embodiments of this application are applicable. It should be noted that the following application scenarios are merely some examples, and is not a limitation on the technical solutions of this application. This application is still applicable to another application scenario.

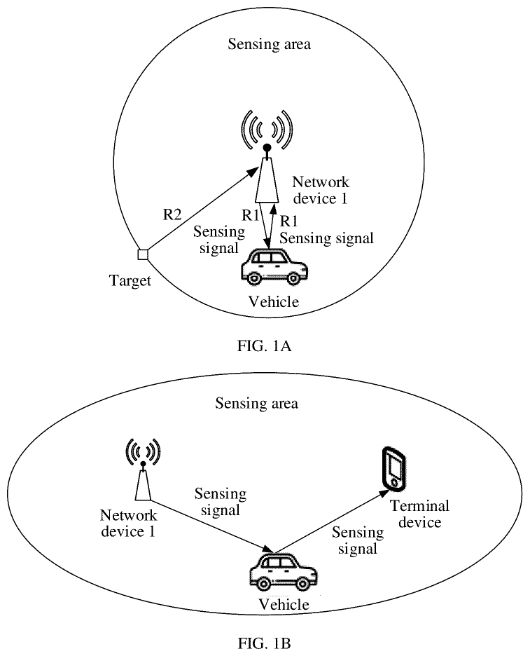

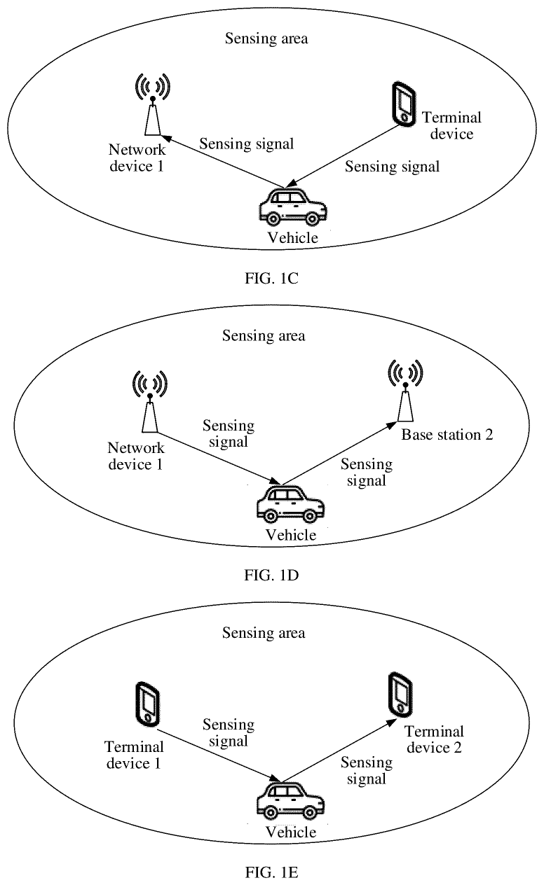

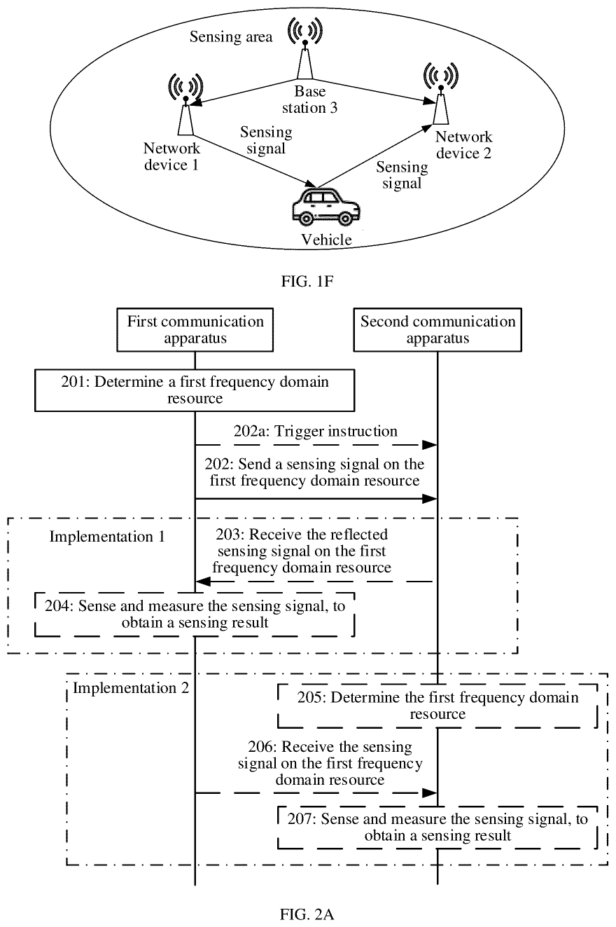

FIG. 1A is a diagram of an application scenario according to an embodiment of this application. FIG. 1A is a specific example of a case in which a first communication apparatus in a communication system serves as both a transmitter of a sensing signal and a receiver of the sensing signal.

In FIG. 1A, the first communication apparatus is a network device 1. The network device 1 may select a first frequency domain resource from a frequency domain resource that is for communication and that is of the network device 1. The network device 1 sends the sensing signal on the first frequency domain resource while performing communication. The sensing signal is reflected to the network device 1 through a vehicle (or another sensed object) in an ambient environment. In this way, the network device 1 may sense and measure the sensing signal, to obtain a sensing result. For example, the network device 1 may sense and measure the sensing signal, to obtain a distance from the network device 1 to the vehicle, a speed of the vehicle, and the like.

With reference to FIG. 1B to FIG. 1F, the following describes some specific examples of a case in which a first communication apparatus is a transmitter of a sensing signal and a second communication apparatus is a receiver of the sensing signal.

FIG. 1B is a diagram of another application scenario according to an embodiment of this application. A first communication apparatus is a network device 1, and a second communication apparatus is a terminal device. The terminal device accesses the network device 1. The network device 1 may perform communication with the terminal device. The network device 1 sends a sensing signal on a first frequency domain resource while the network device 1 performs communication with the terminal device. For example, the first frequency domain resource may be determined from a frequency domain resource used for transmission of a downlink signal between the network device 1 and the terminal device. Then, the sensing signal is reflected to the terminal device through a vehicle in an ambient environment. The terminal device may sense the sensing signal, to obtain a sensing result. In this way, the terminal device senses the vehicle in the ambient environment while performing communication.

FIG. 1C is a diagram of another application scenario according to an embodiment of this application. A first communication apparatus is a terminal device, and a second communication apparatus is a network device 1. The terminal device accesses the network device 1, and the terminal device may perform communication with the network device 1. The terminal device sends a sensing signal on a first frequency domain resource while the terminal device performs communication with the network device 1. For example, the first frequency domain resource may be determined from a frequency domain resource used for transmission of an uplink signal between the terminal device and the network device 1. The sensing signal is reflected to the network device 1 through a vehicle in an ambient environment. The network device 1 may sense the sensing signal, to obtain a sensing result. In this way, the network device 1 senses the vehicle in the ambient environment while performing communication.

FIG. 1D is a diagram of another application scenario according to an embodiment of this application. A first communication apparatus is a network device 1, and a second communication apparatus is a base station 2. The network device 1 may perform communication with the base station 2. The network device 1 sends a sensing signal on a first frequency domain resource while the network device 1 performs communication with the base station 2. The first frequency domain resource may be determined from a frequency domain resource for communication between the network device 1 and the base station 2. The sensing signal is reflected to the base station 2 through a vehicle in an ambient environment, and the network device 2 may sense the sensing signal, to obtain a sensing result. In this way, the base station 2 senses the vehicle in the ambient environment while performing communication.

FIG. 1E is a diagram of another application scenario according to an embodiment of this application. A first communication apparatus is a terminal device 1, and a second communication apparatus is a terminal device 2. The terminal device 1 may perform communication with the terminal device 2. The terminal device 1 may send a sensing signal on a first frequency domain resource while the terminal device 1 performs communication with the terminal device 2. For example, the first frequency domain resource may be determined from a frequency domain resource for communication between the terminal device 1 and the terminal device 2. The sensing signal is reflected to the terminal device 2 through a vehicle in an ambient environment. The terminal device 2 senses the sensing signal, to obtain a sensing result. The application scenario shown in FIG. 1E may be applied to a V2X system or a D2D system.

FIG. 1F is a diagram of another application scenario according to an embodiment of this application. In FIG. 1F, a first communication apparatus is a network device 1, a second communication apparatus is a network device 2, and a third communication apparatus is a base station 3. The network device 1 may perform communication with the network device 2. The base station is a control node, and is configured to notify the network device 1 and the network device 2. For example, the base station 3 may trigger the network device 1 to send a sensing signal, and trigger the network device 2 to enable a sensing function. The network device 1 may send the sensing signal on a first frequency domain resource. The first frequency domain resource may be determined from a frequency domain resource for communication between the network device 1 and the network device 2. The sensing signal is reflected to the network device 2 through a vehicle in an ambient environment, and the network device 2 may sense the sensing signal, to obtain a sensing result. In this way, the network device 2 senses the ambient environment while performing communication.

The following describes some technical terms in this application.
1. Frequency baseline: A frequency of one frequency point minus a frequency of another frequency point. The frequency baseline has a direction and a magnitude. For two frequency points whose frequencies are fᵢ and fⱼ, the two frequency points may form a pair of frequency baselines: a frequency baseline bᵢⱼ=fᵢ−fⱼ and a frequency baseline bᵢⱼ=fⱼ−fᵢ.
2. Frequency baseline redundancy: A plurality of same frequency baselines exist on a frequency domain resource, which is referred to as that the frequency baseline redundancy exists. For example, as shown in FIG. 6A, frequencies of subcarriers included in a subcarrier combination are respectively f₀, f₁, f₂, f₃, f₄, f₅, and f₆. The subcarriers included in the subcarrier combination are sorted in ascending order of the frequencies. Frequency spacings between adjacent subcarriers are the same, to be specific, the subcarriers included in the subcarrier combination are evenly distributed in frequency domain. f₁ and f₂ may form a frequency baseline b₂₁=f₂−f₁, and f₂ and f₃ may form a frequency baseline b₃₂=f₃-f₂. Because the subcarriers are evenly distributed, f₂−f₁=f₃-f₂, to be specific, the frequency baseline b₂₁ and the frequency baseline b₃₂ are same frequency baselines. In this case, it is referred to as that the frequency baseline redundancy exists.

The following describes technical solutions in this application with reference to specific embodiments. In the following embodiments, application scenarios in FIG. 1B to FIG. 1E are applicable. When a first communication apparatus and a second communication apparatus are a same communication apparatus, the application scenario in FIG. 1A is applicable. In some embodiments, the application scenario in FIG. 1F is also applicable.

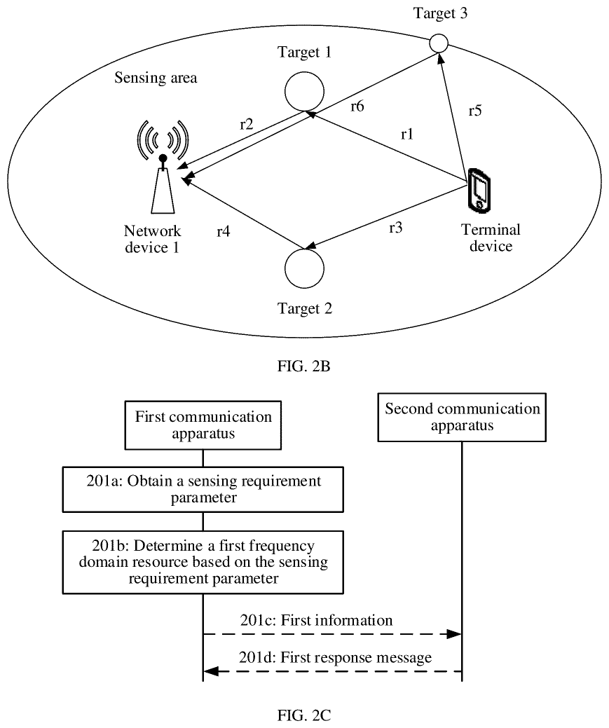

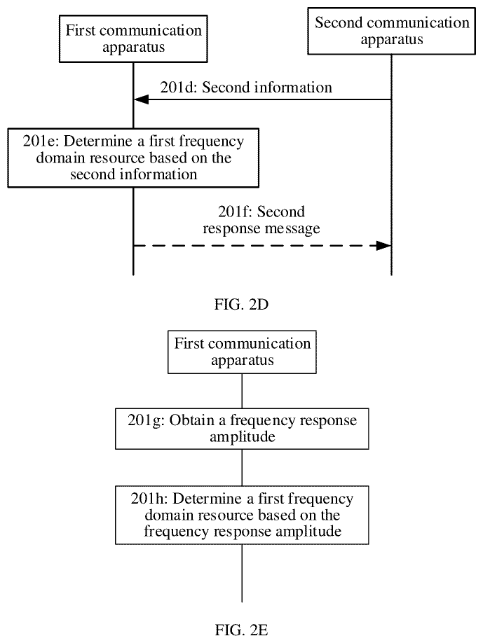

FIG. 2A is a diagram of an embodiment of a communication method according to an embodiment of this application. In FIG. 2A, the communication method includes the following steps.

201: A first communication apparatus determines a first frequency domain resource.

The first frequency domain resource meets a frequency baseline P-level redundancy distribution, and Pis a positive integer.

The P-level redundancy distribution meets a first condition and a second condition.

In this embodiment, a frequency domain resource pool includes an available frequency domain resource configured for the first communication apparatus. For example, the frequency domain resource pool includes a frequency domain resource for communication and/or a frequency domain resource for positioning. The first frequency domain resource may be determined from the frequency domain resource for communication and/or the frequency domain resource for positioning.

Optionally, the frequency domain resource pool includes a frequency domain resource used for transmission of a channel state information (CSI) reference signal between the first communication apparatus and a second communication apparatus. Alternatively, the frequency domain resource pool includes a frequency domain resource used for transmission of communication data between the first communication apparatus and a second communication apparatus. In other words, the first frequency domain resource in this application may be a frequency domain resource determined from the frequency domain resource used by the first communication apparatus for transmission of the CSI and/or the frequency domain resource used by the first communication apparatus for transmission of the communication data.

Optionally, the first frequency domain resource includes a frequency point combination or a frequency band combination.

The frequency point combination includes one or more frequency points. The frequency band combination includes one or more frequency bands.

For example, the frequency point combination includes a frequency point 0, a frequency point 2, a frequency point 4, and a frequency point 6. A frequency of the frequency point 0 is f₀, a frequency of the frequency point 2 is f₂, a frequency of the frequency point 4 is f₄, and a frequency of the frequency point 6 is f₆.

For example, the frequency band combination includes a frequency band from the frequency f₀ to the frequency f₆.

The first condition includes: Frequency baselines formed by the first frequency domain resource include a frequency baseline of a first length. The first length is k*length of a minimum frequency baseline, k is a positive integer belonging to [1, K], K is a ratio of a length of a maximum frequency baseline to the length of the minimum frequency baseline, and K is greater than 1.

For example, the frequencies of the frequency points included in the frequency point combination are respectively 0, 1, 4, and 6. It can be learned that, in a frequency baseline formed by the frequency point combination, a frequency baseline of a smallest length is 1, and a frequency baseline of a largest length is 6. The ratio of the length of the maximum frequency baseline to the length of the minimum frequency baseline is 6. A frequency point baseline that can be obtained through construction by using the frequency point combination includes a frequency baseline whose frequencies are respectively −6, −5, −4, −3, −2, −1, 0, 1, 2, 3, 4, 5 and 6. It may be understood that the frequency point combination meets a requirement of frequency baseline coverage completeness.

The length of the maximum frequency baseline is |bₘₐₓ|, and the length of the minimum frequency baseline is |bₘᵢₙ|. It can be learned that K=|bₘₐₓ|/|bₘᵢₙ|. If all frequency baselines of a length of k|bₘᵢₙ| can be obtained through construction by using the frequency points included in the frequency point combination, the frequency point baseline formed by the frequency point combination is completely covered in frequency, in other words, frequency point baseline coverage completeness is ensured. When the frequency point combination forms a plurality of frequency baselines of different lengths, a plurality of targets in an ambient environment can be sensed and ranged. A larger quantity of frequency baselines of different lengths indicates better sensing and ranging effects.

For example, when the frequency point combination can form only one frequency baseline d₁, the following relationship y₁=f(d₁, τ₁) is obtained. d₁ indicates the frequency baseline, τ₁ indicates a delay, y₁ indicates a measurement result corresponding to the frequency baseline d₁, and f indicates a mapping relationship of y₁ obtained based on the frequency baseline d₁ and the delay τ₁. The delay τ₁ is unknown. To be specific, one equation corresponds to one unknown number. The delay τ₁ may be understood as a delay for sensing signals on two frequency points that form the frequency baseline d₁ to arrive at a target 1 and then be reflected.

However, when both the delay τ₁ and a delay τ2 exist, the following relationship y₁=f₁(d₁, τ₁, [2) is obtained. The delay τ₁ and the delay τ₂ are unknown. In this case, one equation corresponds to two unknown numbers, and the equation cannot be solved. The delay 2 may be understood as a delay for sensing signals on two frequency points that form the frequency baseline d₂ to arrive at a target 2 and then be reflected. However, if the frequency point combination may further form another frequency baseline d₂, another equation y₂=f₂(d₂, τ₁, τ₂) may be obtained. In this way, the frequency baseline d₁ and the frequency baseline d₂ respectively correspond to two equations, and the two unknown numbers, namely the delay τ₁ and the delay τ₂, can be solved. Then, position information of the target 1 and the target 2 may be determined with reference to the delay τ₁ and the delay τ₂. Therefore, if the frequency point baseline formed by the frequency point combination is completely covered in frequency, the plurality of targets in the ambient environment can be sensed and ranged.

Complete baseline coverage can reduce a side lobe level of an ambiguous ranging function, to reduce impact of interference. Incomplete baseline coverage results in a high side lobe level, and it is likely to cause a side lobe of a strong target to cover a weak target. More incomplete baseline coverage indicates stronger interference.

In an actual channel environment, channel frequency-selective fading inevitably occurs, and consequently, a signal-to-noise ratio of measurement values of the baseline formed by the frequencies is poor. In an extreme case, the signal-to-noise ratio may even be lower than a background noise level, and invalid measurement values are formed. In this case, effective complete baseline coverage cannot be met, thereby causing interference.

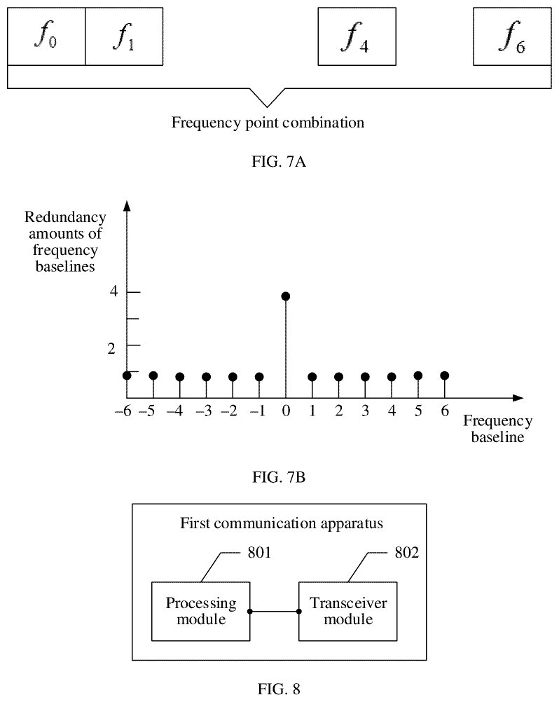

For example, as shown in FIG. 7A, frequencies of subcarriers included in a subcarrier combination are respectively f₀, f₁, f₄, and f₆, and f₀, f₁, f₄, f₆ are 0, 1, 4, 6 respectively. The first communication apparatus performs sensing and ranging by using the subcarriers included in the subcarrier combination. A length |bₘᵢₙ| of a minimum frequency baseline in a frequency baseline formed by the subcarriers included in the subcarrier combination is 1, and a length |bₘₐₓ| of maximum frequency baseline is 6. FIG. 7B shows a coverage situation and a redundancy situation that are of the frequency baseline and that may be determined by using the subcarrier combination. It can be learned from FIG. 7B that a frequency baseline of a length of k|bₘᵢₙ| may be obtained through construction by using the subcarrier combination, and k belongs to [−6, −5, −4, −3, −2, −1, 0, 1, 2, 3, 4, 5, 6]. Therefore, frequency baseline coverage is complete. It can be learned from FIG. 7B that redundancy exists only on a frequency baseline 0, and no redundancy exists on other frequency baselines. For example, when f₄ appears at a position of frequency-selective fading, a frequency baseline that is of a length of 2 and that is formed by f₄ and f₆ is invalid, and the frequency baseline of the length of 2 is missing in a distribution of a frequency baseline obtained through measurement.

To overcome this problem, a quantity of frequency baseline redundancy times may be increased. Information obtained by a receiver of the sensing signal from a redundancy frequency baseline is the same. Therefore, even if frequency-selective fading appears at positions of some frequencies, causing measurement values of a frequency baseline formed by the frequencies to be invalid, other frequencies may be used to form the frequency baseline, thereby reducing a possibility of frequency baseline missing. In addition, measured noise of redundancy baselines is independent of each other, and performing redundancy averaging on the redundancy baselines can improve a measured signal-to-noise ratio. More redundancy indicates larger improvement of signal-to-noise ratio. For example, in the foregoing example, a subcarrier f3 with a frequency of 3 is added, and a length of a frequency baseline formed by f3 and f1 is also 2, that is, redundancy exists on the frequency baseline of the length of 2. When f4 appears at the position of frequency-selective fading, measurement values of the frequency baseline that is of the length of 2 and that is formed by f4 and f6 are invalid. However, measurement values of the frequency baseline that is of the length of 2 and that is formed by f3 and f1 are still valid, and the frequency baseline of the length of 2 still exists in the distribution of the frequency baseline obtained through measurement.

The frequency-selective fading is random, and fading may occur on frequency points. Therefore, all frequency baselines need to be redundant. When a plurality of frequency points fade, multi-level redundancy is needed.

Therefore, the second condition further needs to be met. The second condition includes: Redundancy distribution counts of all frequency baselines except largest (P−1) and smallest (P−1) frequency baselines are greater than or equal to P.

Optionally, a quantity of redundancy times of the largest P−1 frequency baselines is p, and p is numbers of frequency baselines sorted in descending order. For example, a largest frequency baseline corresponds to a redundancy count, 1, and a second largest frequency baseline corresponds to a redundancy count, 2. The rest can be deduced by analogy. Similarly, a quantity of redundancy times of the smallest P−1 frequency baselines is q, and q is numbers of frequency baselines sorted in ascending order. It may be understood that, in all possible frequency baseline distributions, a maximum quantity of redundancy times of the largest P−1 frequency baselines is p. For example, the largest frequency baseline can be obtained only by subtracting a smallest frequency point from a largest frequency point, and the maximum quantity of redundancy times is 1.

It may be understood that, when P is equal to 1, the second condition is that the redundancy distribution counts of all the frequency baselines are greater than or equal to 1, and this is equivalent to that there is no redundancy, that is, only the first condition needs to be met.

When the P-level redundancy distribution is met, the complete baseline coverage can still be ensured even if P−1 frequency points are invalidated. Because it is difficult to accurately predict a quantity of fading frequency points, a larger value of P indicates a lower possibility of interference but higher overheads. A value of P may be set based on a degree of frequency-selective fading, or may be obtained based on another constraint. A larger frequency response amplitude difference indicates a higher frequency fading degree. The value of P may be set based on a frequency response amplitude. The frequency response amplitude may be obtained by using the CSI, or may be obtained by testing the sensing signal in frequency domain in the frequency domain resource pool.

The first frequency domain resource may be determined from the frequency domain resource pool based on a sensing requirement parameter.

In this embodiment, the sensing requirement parameter is used by the first communication apparatus or the second communication apparatus to perform sensing and measurement by using the sensing signal. For example, the sensing requirement parameter may represent a requirement for performing sensing and ranging by using the sensing signal.

The sensing requirement parameter may include at least one of the following: an unambiguous ranging distance, a ranging resolution, and sensing resource usage.

Specifically, the unambiguous ranging distance and the ranging resolution represent requirements for performing sensing and ranging by using the sensing signal.

In this embodiment, the ranging resolution refers to a minimum distance that distinguishes two same targets in distance.

The two same targets may be two targets that have a same size, volume, material, and the like.

A lower ranging resolution requires a smaller minimum distance for which the first communication apparatus can distinguish the two same targets. That is, a lower ranging resolution requires higher sensing accuracy.

For example, as shown in FIG. 2B, a terminal device sends the sensing signal on the first frequency domain resource. The sensing signal is reflected to a network device 1 separately through the target 1 and the target 2. A sum of a distance from the terminal device to the target 1 and a distance from the target 1 to the network device 1 is r1+r2. A sum of a distance from the terminal device to the target 2 and a distance from the target 2 to the network device 1 is r3+r4. The ranging resolution is Δr. If |(r3+r4)−(r1+r2)| is greater than or equal to Δr, the network device 1 may distinguish the target 1 and the target 2. If |(r3+r4)−(r1+r2)| is less than Δr, the network device 1 may not be capable of distinguishing the target 1 and the target 2, and the network device 1 considers that there is only one target.

It should be noted that the ranging resolution is directly proportional to bandwidth of the sensing signal. Larger bandwidth of the sensing signal indicates a higher ranging resolution.

In this embodiment, optionally, when the first communication apparatus serves as a transmitter and the receiver of the sensing signal, the unambiguous ranging distance indicates the following requirements: A distance from any point in a sensing area to the first communication apparatus multiplied by two is less than the unambiguous ranging distance, and a distance from any point on an edge of the sensing area to the first communication apparatus multiplied by two is equal to the unambiguous ranging distance.

For example, as shown in FIG. 1A, the sensing area is a circular area shown in FIG. 1A, and the network device 1 is the center of the circle. The unambiguous ranging distance is rₘₐₓ. Twice a distance from any point on the circle to the network device 1 is equal to the unambiguous ranging distance rₘₐₓ. A vehicle is located in the circular area, and a distance from the network device 1 to the vehicle is R1. For the vehicle in the circular area in FIG. 1A, a value obtained by multiplying the distance R1 from the network device 1 to the vehicle by 2 is less than rₘₐₓ. For the target on the circle in FIG. 1A, a distance from the target to the network device 1 is R2, and a value obtained by multiplying the distance R2 between the target and the network device 1 by 2 is equal to rₘₐₓ.

In this embodiment, optionally, when the first communication apparatus serves as a transmitter of the sensing signal and the second communication apparatus serves as the receiver of the sensing signal, the unambiguous ranging distance indicates the following requirements: A sum of a distance from any point in the sensing area to the first communication apparatus and a distance from the point to the second communication apparatus is less than the unambiguous ranging distance, and a sum of a distance from any point on an edge of the sensing area to the first communication apparatus and a distance from the point to the second communication apparatus is equal to the unambiguous ranging distance.

For example, as shown in FIG. 2B, the sensing area is an elliptical area shown in FIG. 2B, and the network device 1 and the terminal device are two focal points of the ellipse. The unambiguous ranging distance is rₘₐₓ, and a sum of a distance from any point on the ellipse to the network device 1 and a distance from the point to the terminal device is equal to the unambiguous ranging distance rₘₐₓ. The target 1 and the target 2 are located in the elliptic area, and a target 3 is located on the ellipse. The terminal device sends the sensing signal on the first frequency domain resource. The sensing signal is reflected to the network device 1 separately through the target 1 and the target 2. For the target 1 located in the elliptic area, the sum of the distance from the terminal device to the target 1 and the distance from the target 1 to the network device 1 is r1+r2, and r1+r2 is less than rₘₐₓ. For the target 3 located on the ellipse, a sum of a distance from the terminal device to the target 3 and a distance from the target 3 to the network device 1 is r5+r6, and r5+r6 is equal to Imax.

The following describes the first frequency domain resource with reference to specific content included in the sensing requirement parameter.

In a first possible implementation, the sensing requirement parameter includes the unambiguous ranging distance, the first frequency domain resource meets a minimum frequency baseline threshold, and the minimum frequency baseline threshold is determined based on the unambiguous ranging distance.

First, an example in which the first frequency domain resource includes the frequency point combination is used for description. The unambiguous ranging distance is rₘₐₓ. Therefore, the minimum frequency baseline threshold is

$$\vert {b}_{min \_ thresh} \vert = \frac{c}{{r}_{max}} ,$$

where c is a propagation speed of light under atmospheric standard conditions. If the frequency baseline formed by the frequency point combination includes a frequency baseline whose length is less than or equal to |b_{min_thresh}|, it may be considered that the frequency point combination meets the minimum frequency baseline threshold.

For example, the frequency point combination includes the frequency point 0, the frequency point 2, the frequency point 4, and the frequency point 6. The frequency points in the frequency point combination are sorted in ascending order of the frequencies. The frequency of the frequency point 0 is f₀, the frequency of the frequency point 2 is f₂, the frequency of the frequency point 4 is f₄, and the frequency of the frequency point 6 is f₆.

The unambiguous ranging distance is rₘₐₓ. Therefore, the minimum frequency baseline threshold is

$$\vert {b}_{min \_ thresh} \vert = \frac{c}{{r}_{max}} .$$

In frequency baselines formed by two different frequency points in the frequency point combination, a length of a frequency baseline formed by the frequency point 0 and the frequency point 2 is |f₀−f₂|, and |f₀−f₂| is equal to |b_{min_thresh}|. In this case, it may be understood that the frequency point combination meets the minimum frequency baseline threshold.

From a perspective of independent use of a frequency point resource by a single device, the frequency baseline formed by the frequency point combination includes the frequency baseline whose length is less than or equal to b_{min_thresh}. In this way, the frequency point combination may also meet a requirement of the minimum frequency baseline threshold, but a waste of frequency point resources may be caused. Therefore, in the frequency baseline formed by the frequency point combination, provided that the length of the frequency baseline of a smallest length is |b_{min_thresh}|, the requirement of the minimum frequency baseline threshold can be met, and the waste of frequency point resources can be avoided.

From a perspective of sharing a frequency point resource by a plurality of devices, when the frequency points included in the frequency point combination are selected, a frequency point reuse rate may be considered, thereby improving resource utilization and saving frequency point resources.

For example, when a frequency point combination determined by the device 1 includes the frequency point 0 and the frequency point 1, the frequency of the frequency point 0 is f₀, and the frequency of the frequency point 1 is f₁, |f₀−f₁| is equal to a minimum frequency baseline threshold required by the device 1. If |f₀-fil is less than a minimum frequency baseline threshold required by a device 2, the device 2 may select the frequency point 0 and the frequency point 1. In this way, frequency point resource utilization of the frequency point 0 and the frequency point 1 can be improved, thereby saving frequency point resources.

For example, if the unambiguous ranging distance rₘₐₓ is equal to 100 m, it may be determined, according to a formula

$$\vert {b}_{min \_ thresh} \vert = \frac{c}{{r}_{max}} ,$$

that the length of the minimum frequency baseline is 3 megahertz (MHz). The frequency domain resource pool includes a 3.5 gigahertz (GHz) frequency band, which is expressed as {f(a)|f(a)=3.5*10⁹+a*15*10³, 0≤a≤1000}, where f(a) is in a unit of hertz (Hz). In this case, a smallest frequency point is 3.5 GHZ, and a largest frequency point is 3.515 GHz. Other frequency points are selected from f(a) at an interval of 15 kHz, to obtain a frequency point combination 1. Then, frequency points are selected from the frequency point combination 1, to obtain a frequency point combination 2. The frequency point combination 2 is specifically expressed as {f(m)|f(m)=3.5*10⁹+m*15*10³, m=0, 200, 400, 600, 800, 1000}, where f(m) is in a unit of hertz (Hz). The frequency point combination 2 serves as the first frequency domain resource. In a frequency baseline formed by two different frequency points in the frequency point combination 2, a length of a frequency baseline formed by the frequency point 3.5 GHz and a frequency point 3.503 GHz is 3 MHz. Therefore, it may be understood as that the frequency point combination 2 meets the minimum frequency baseline.

In a second possible implementation, the sensing requirement parameter includes the ranging resolution, the first frequency domain resource meets a maximum frequency baseline threshold, and the maximum frequency baseline threshold is determined based on the ranging resolution.

First, an example in which the first frequency domain resource includes the frequency point combination is used for description. The ranging resolution is Δr. Therefore, it can be learned that the maximum frequency baseline threshold is

$$\vert {b}_{max \_ thresh} \vert = \frac{c}{Δ r} ,$$

where c is a propagation speed of light under atmospheric standard conditions. If the frequency baseline formed by the frequency point combination includes a frequency baseline whose length is greater than or equal to |b_{max_thresh}|, it may be considered that the frequency point combination meets the maximum frequency baseline threshold.

For example, the frequency point combination includes the frequency point 0, the frequency point 2, the frequency point 4, and the frequency point 6. The frequency points in the frequency point combination are sorted in ascending order of the frequencies. The frequency of the frequency point 0 is f₀, the frequency of the frequency point 2 is f₂, the frequency of the frequency point 4 is f₄, and the frequency of the frequency point 6 is f₆.

The ranging resolution is Δr. Therefore, the maximum frequency baseline threshold is

$$\vert {b}_{max \_ thresh} \vert = \frac{c}{Δ r} .$$

In a frequency baseline into which two different frequency points in the frequency point combination are combined, a length of a frequency baseline formed by the frequency point 0 and the frequency point 6 is |f₀−f₆|, and |f₀−f₆| is equal to |b_{max_thresh}|. In this case, it may be understood that the frequency point combination meets the maximum frequency baseline threshold.

From a perspective of independent use of a frequency point resource by a single device, the frequency baseline formed by the frequency point combination includes the frequency baseline whose length is greater than or equal to |b_{max_thresh}|. In this way, the frequency point combination may also meet a requirement of the maximum frequency baseline threshold, but a waste of frequency point resources may be caused. Therefore, in the frequency baseline formed by the frequency point combination, provided that the length of the frequency baseline of a largest length is |b_{max_thresh}|, the requirement of the maximum frequency baseline threshold can be met, and the waste of frequency point resources can be avoided.

From a perspective of sharing a frequency point resource by a plurality of devices, when the frequency points included in the frequency point combination are selected, a frequency point reuse rate may be considered, thereby improving resource utilization and saving frequency point resources. For example, when a frequency point combination determined by the device 1 includes the frequency point 0, the frequency point 2, the frequency point 4, and the frequency point 7, the frequency points in the frequency point combination are sorted in ascending order of the frequencies. |f₀−f₇| is equal to a maximum frequency baseline threshold required by the device 1. |f₀−f₇| is greater than a maximum frequency baseline threshold required by a device 2. The device 1 determines that the frequency point combination meets the maximum frequency baseline threshold required by the device 1. The device 2 may select the frequency point 0, the frequency point 2, the frequency point 4, and the frequency point 7. In this way, frequency point resource utilization of the frequency point 0, the frequency point 2, the frequency point 4, and the frequency point 7 can be improved, thereby saving frequency point resources.

For example, if the ranging resolution is Δr=10 meters (m), it may be determined, according to a formula

$$\vert {b}_{max \_ thresh} \vert = \frac{c}{Δ r} ,$$

that the required maximum frequency baseline threshold is 30 MHz. The frequency domain resource pool includes a 3.5-GHz frequency band, which is expressed as {f(i)|f(i)=3.5*10⁹+i*15*10³, 0≤i≤2000}, where f(i) is in a unit of Hz. In this case, a smallest frequency point is 3.5 GHZ, and a largest frequency point is 3.53 GHz. Other frequency points are selected from f(i) at an interval of 15 kHz, to obtain a frequency point combination 3. Then, frequency points are selected from the frequency point combination 3, to obtain a frequency point combination 4. The frequency point combination 4 is specifically expressed as {f(n)|f(n)=3.5*10⁹+n*15*10³, n=0, 200, 400, 600, 800, 1000, 1200, 1400, 1600, 1800, 2000}, where f(n) is in a unit of Hz. In a frequency baseline formed by two different frequency points in the frequency point combination 4, a length of a frequency baseline formed by the frequency point 3.5 GHz and the frequency point 3.53 GHz is 30 MHz. Therefore, the frequency point combination 4 meets the maximum frequency baseline threshold.

The following uses an example in which the first frequency domain resource includes the frequency band combination for description. The frequency band combination includes one or more frequency bands. The ranging resolution is Δr. Therefore, it can be learned that the maximum frequency baseline threshold is

$$\vert {b}_{max \_ thresh} \vert = \frac{c}{Δ r} ,$$

where c is a propagation speed of light under atmospheric standard conditions. If a length of the frequency baseline formed by frequency bands included in the frequency band combination includes the frequency baseline greater than or equal to b_{max_thresh}|, it may be considered that the frequency band combination meets the maximum frequency baseline threshold.

For example, the frequency band combination includes a frequency band whose frequencies are f₀ to f₃, and a frequency band whose frequencies are f₆ to f₉. f₀ is greater than f₃, f₃ is greater than f₆, and f₆ is greater than f₉. A smallest frequency is f₀, and a largest frequency is f₉. In this case, a length of a frequency baseline of a largest length in frequency baselines formed by the frequency bands included in the frequency band combination is |f₀−f₉|. If |f₀−f₉| is greater than or equal to the frequency baseline of b_{max_thresh}, it may be considered that the frequency band combination meets the maximum frequency baseline threshold.

In a third possible implementation, the sensing requirement parameter includes the unambiguous ranging distance and the ranging resolution, and the first frequency domain resource meets a minimum frequency baseline threshold and a maximum frequency baseline threshold.

The minimum frequency baseline threshold is determined based on the unambiguous ranging distance. The maximum frequency baseline threshold is determined based on the ranging resolution.

Herein, an example in which the first frequency domain resource includes the frequency point combination is used for description. The unambiguous ranging distance is rₘₐₓ, and the ranging resolution is Δr. Therefore, the minimum frequency baseline threshold is

$$\vert {b}_{min \_ thresh} \vert = \frac{c}{{r}_{max}} ,$$

and the maximum frequency baseline threshold is

$$\vert {b}_{max \_ thresh} \vert = \frac{c}{Δ r} .$$

If a frequency baseline formed by a frequency combination should include a frequency baseline whose length is less than or equal to |b_{min_thresh} and a frequency baseline whose length is greater than or equal to b_{max_thresh}|, it may be considered that the frequency point combination meets the maximum frequency baseline threshold and the minimum frequency baseline threshold.

For example, the frequency point combination includes the frequency point 0, the frequency point 2, the frequency point 4, and the frequency point 6. The frequency points in the frequency point combination are sorted in ascending order of the frequencies. The frequency of the frequency point 0 is f₀, the frequency of the frequency point 2 is f₂, the frequency of the frequency point 4 is f₄, and the frequency of the frequency point 6 is f₆.

In a frequency baseline into which two different frequency points in the frequency point combination are combined, a length of a frequency baseline formed by the frequency point 0 and the frequency point 2 is |f₀−f₂|. A length of a frequency baseline formed by the frequency point 0 and the frequency point 6 is |f₀−f₆|. If |f₀−f₂| is less than or equal to b_{min_thresh}|, it may be understood that the frequency point combination meets the minimum frequency baseline threshold. If |f₀−f₆| is greater than or equal to b_{max_thresh}|, it may be understood that the frequency point combination meets the maximum frequency baseline threshold. In other words, the frequency point combination meets both the minimum frequency baseline threshold and the maximum frequency baseline threshold.

For example, if the unambiguous ranging distance rₘₐₓ is equal to 100 m, it may be determined, according to a formula

$$\vert {b}_{min \_ thresh} \vert = \frac{c}{{r}_{max}} ,$$

that the required minimum frequency baseline threshold is 3 MHz. If the ranging resolution Δr is equal to 10 m, it may be determined, according to a formula

$$\vert {b}_{max \_ thresh} \vert = \frac{c}{Δ r} ,$$

that the required maximum frequency baseline threshold is 30 MHz. The frequency domain resource pool includes a 3.5 gigahertz (GHz) frequency band, which is expressed as {f(i)|f(i)=3.5*10⁹+i*15×10³, 0≤i≤2000}, where f(i) is in a unit of Hz. In this case, a smallest frequency point is 3.5 GHZ, and a largest frequency point is 3.53 GHZ. Other frequency points are selected from f(i) at an interval of 15 kHz, to obtain a frequency point combination 5. Then, frequency points are selected from the frequency point combination 5, to obtain a frequency point combination 6. The frequency point combination 6 is specifically expressed as {f(n)|f(n)=3.5*10⁹+n*15*10³, n=0, 200, 400, 600, 800, 1000, 1200, 1400, 1600, 1800, 2000}, where f(n) is in a unit of Hz. In a frequency baseline formed by two different frequency points in the frequency point combination 6, a length of a frequency baseline formed by the frequency point 3.5 GHz and a frequency point 3.503 GHz is 3 MHz. Therefore, the frequency point combination 6 meets the minimum frequency baseline threshold. A length of a frequency baseline formed by the frequency point 3.5 GHz and the frequency point 3.53 GHZ is 30 MHz. Therefore, the frequency combination 6 meets the maximum frequency baseline threshold. In other words, the frequency point combination 6 meets both the minimum frequency baseline threshold and the maximum frequency baseline threshold.

In a fourth possible implementation, the sensing requirement parameter includes the sensing resource usage, and the first frequency domain resource meets a maximum quantity N of frequency domain resources. The maximum quantity of frequency domain resources is determined based on the sensing resource usage. A largest quantity M=γN of frequency domain resources that may be used for sensing is obtained through calculation based on the sensing resource usage Y and the total quantity N of available frequency domain resources. The total quantity N of available frequency domain resources may be obtained by the second communication apparatus or a third communication apparatus, or determined by the second communication apparatus or a third communication apparatus.

It may be understood that, when the sensing requirement parameter does not include the sensing resource usage, it is equivalent to that it is considered by default that the sensing resource usage is 100%, that is, the largest quantity M of frequency domain resources that may be used for sensing is equal to the total quantity N of available frequency domain resources.

It may be understood that the fourth possible implementation may be combined with first three possible implementations, and the sensing requirement parameter may include the sensing resource usage, the unambiguous ranging distance, and/or the ranging resolution.

In this embodiment, optionally, the first frequency domain resource includes the frequency point combination. The frequency point combination includes a subcarrier combination. The subcarrier combination is a subcarrier combination that is with a smallest quantity of subcarriers and that is in subcarrier combinations that meet a minimum frequency baseline, a maximum frequency baseline, and a first condition.

Specifically, there may be a plurality of subcarrier combinations that meet the minimum frequency baseline, the maximum frequency baseline, and the first condition, and the subcarrier combination may be a subcarrier combination with a smallest quantity of subcarriers in the plurality of subcarrier combinations. In this way, when the maximum frequency baseline and the minimum frequency baseline are met, and it is ensured that a frequency baseline coverage is complete, the subcarrier combination with the smallest quantity of subcarriers is selected, thereby effectively saving overheads of subcarriers in frequency domain. This avoids that excessive communication resources are occupied and communication performance is affected.

The following describes four implementations of constructing the first frequency domain resource that meets the P-level redundancy distribution. For ease of description, the first frequency domain resource is normalized, and a minimum frequency baseline length serves as a unit length 1. It may be understood that this step does not constitute a limitation on this application, and normalization may not be performed. In the following steps, a same effect is achieved by multiplying a frequency by the minimum frequency baseline length.

In a first possible implementation, a first frequency domain resource set is 1, 2, . . . , and N1, and includes N1 frequency domain resources, and an interval between the frequency domain resources is 1. A second frequency domain resource set is N1+1, 2*(N1+1), . . . , and N2*(N1+1), and includes N2 frequency domain resources, and an interval between the frequency domain resources is N1+1. A third frequency domain resource set is formed by using a union set of the first frequency domain resource set and the second frequency domain resource set, and the third frequency domain resource set meets the first condition.

Specifically, a smallest frequency baseline length of the third frequency domain resource set is 1, K is N2*(N1+1)−1, and the first length is 1, 2, 3, . . . , and N2*(N1+1)−1. Frequency baseline lengths 1, 2, 3, . . . , and N1 may be obtained by using frequency points (N1+1)−(N1), (N1+1) (N1−1), (N1+1)−(N1−2), . . . , and (N1+1)−(1), and frequency baseline lengths N1+1, . . . , and 2*(N1+1)−1 may be obtained by using frequency points (2*(N1+1))−(N1+1), (2*(N1+1))−(N1), (2*(N1+1))−(N1−1), . . . , and (2*(N1+1))−(1). The rest can be deduced by analogy. The first length may be obtained through construction by using the frequency points of the third frequency domain resource set. It may be understood that the frequency point combination meets the requirement of frequency baseline coverage completeness.

The third frequency domain resource set is separately shifted by 0, 1, 2, . . . , and P−1 units and a union set is obtained, to obtain the first frequency domain resource, where Pis a positive integer. Shifting p units means adding p to each frequency point in the set. For example, the third frequency domain resource set is {1, 4, 6}, and two units are shifted to obtain {3, 6, 8}. It may be understood that, in the first frequency domain resource, frequency points added to the first frequency domain resource set after shifting are included in frequency points obtained by shifting the second frequency domain resource set. Therefore, the second frequency domain resource set may be separately shifted by 0, 1, 2, . . . , and P−1 units, to obtain a union set together with the first frequency domain resource set, to obtain a same result. Alternatively, the first frequency domain resource may be directly expressed as 1, 2, . . . , N1+P, 2*(N1+1), 2*(N1+1)+1, . . . , 2*(N1+1)+P−1, . . . , N2*(N1+1), N2*(N1+1)+1, . . . , and N2*(N1+1)+P−1.

It may be understood that the first frequency domain resource meets the P-level redundancy distribution. Specifically, because the third frequency domain resource set meets complete frequency baseline coverage, that is, meets a one-level redundancy distribution, frequency baselines formed by sets obtained by shifting the third frequency domain resource set are the same, and also meet the complete frequency baseline coverage, that is, meet the one-level redundancy distribution. The third frequency domain resource set is shifted and a union set is obtained, to obtain the first frequency domain resource. A value range of the frequency baselines formed by the first frequency domain resource is the same as that of frequency baselines formed by the third frequency domain resource set, except that the largest (P−1) and smallest (P−1) frequency baselines are added. In the first frequency domain resource, there are at least P frequency baselines except the largest (P−1) and smallest (P−1) frequency baselines. In addition, an interval between a largest P−1 frequency point of the first frequency domain resource and a smallest P−1 frequency point of the first frequency domain resource is 1, and it is met that redundancy counts of the largest P−1 frequency baselines are p, where p is numbers of frequency baselines sorted in descending order, and redundancy counts of the smallest P−1 frequency baselines are q, where q is numbers of frequency baselines sorted in ascending order. Therefore, the first frequency domain resource meets the P-level redundancy distribution.

When P is equal to 1, because the third frequency domain resource set meets the complete frequency baseline coverage, that is, meets the one-level redundancy distribution, the requirement can be met by shifting 0 (that is, without shifting).

It may be understood that, when P≥N1+1, because third frequency resource sets before and after shifting overlap with each other, and it cannot be ensured that a condition of the P-level redundancy distribution is met, P<N1+1.

It may be understood that a quantity of frequency points included in the first frequency domain resource is N1+P*N2.

Parameters N1, N2, and P of the first frequency domain resource are determined based on the minimum frequency baseline |bₘᵢₙ|, the maximum frequency baseline |bₘₐₓ|, and the largest quantity of frequency domain resources. Specifically, a largest normalized frequency baseline of the first frequency domain resource is N2*(N1+1)+P−1, and should satisfy N2*(N1+1)+P−1≥|bₘₐₓ|/|bₘᵢₙ|. The total quantity of available frequency domain resources N and a quantity of frequency domain resources included in the first frequency domain resource N1+P*N2 should satisfy N≥N1+P*N2.

Optionally, the sensing requirement parameter further includes the sensing resource usage γ. The largest quantity M=γN of frequency domain resources that may be used for sensing is obtained through calculation based on the sensing resource usage and the total quantity N of available frequency domain resources. The total quantity N of available frequency domain resources may be obtained by the second communication apparatus or the third communication apparatus, or determined by the second communication apparatus or the third communication apparatus. The quantity of frequency domain resources included in the first frequency domain resource is N1+P*N2, and should satisfy M≥N1+P*N2.

Optionally, when the foregoing condition is met, a largest value of P is selected, to implement more redundancy counts.

Optionally, the value of P is determined based on a channel condition. N1 and N2 are determined based on the value of P and the foregoing condition. When the channel condition is good, the frequency-selective fading is little, and a small value of P may be selected to ensure the complete frequency baseline coverage at a high probability. When the channel condition is poor, the frequency-selective fading is much, and a large value of P may be selected to ensure the complete frequency baseline coverage at the high probability.

For example, for a 5G NR signal whose frequency band range is FR1, maximum total available bandwidth is approximately 100 MHz. For example, a subcarrier spacing is 30 kHz, and the maximum available bandwidth is 98.28 MHz. A total quantity of subcarriers is 3276, a quantity of subcarriers that may be used for sensing cannot be greater than 60, that is, the total quantity N of available frequency domain resources is equal to 60. If the unambiguous ranging distance rₘₐₓ is equal to 390 m, it may be determined, according to a formula

$$\vert {b}_{min \_ thresh} \vert = \frac{c}{{r}_{max}} ,$$

that the minimum frequency baseline threshold is 769.2 kHz. If the ranging resolution Δr is equal to 3.1 m, it may be determined, according to a formula

$$\vert {b}_{max \_ thresh} \vert = \frac{c}{Δ r} ,$$

that the required maximum frequency baseline threshold is 96.8 MHz. A maximum baseline length and a minimum baseline length each are set to an integer multiple of the subcarrier spacing. The maximum baseline length should be greater than the maximum baseline length threshold, and is set to └96.8 MHz/30 KHz┘* 30 KHz=96.81 MHz, where ┌a┐ indicates that a rounding-up operation is performed on a number a. The minimum baseline length should be less than the minimum baseline length threshold, and is set to └769.2 KHz/30 KHz┘*30 KHz=750 KHz, where └a┘ indicates that a rounding-down operation is performed on a. The maximum baseline length should be an integer multiple of the minimum baseline length. Therefore, the maximum baseline length is further adjusted to ┌96.81 MHz/750 KHz┐*750 KHz=97.5 MHz. A subcarrier set [symbol] ={fₙ=fₘᵢₙ+(n−1)*750 KHz|n∈[1, 131]} is obtained based on the minimum baseline length and the maximum baseline length. After the sensed subcarrier set S is determined, a multi-level redundancy structure is further obtained through design in a nesting manner, and the parameters N1, N2, and P are determined. N₂(N₁+1)+P≥|bₘₐₓ|/|bₘᵢₙ|=130, and N₁+PN₂≤N=60 need to be satisfied, and a largest value of P is obtained through optimized design. After the optimized design, the largest value of P may be 4, and all three groups of values correspond to P=4. The three groups of values are respectively N1=13, N2=9, and P=4; N1=17, N2=7, and P=4; and N1=20, N2=6, and P=4. Under a given condition, a four-level redundancy frequency baseline distribution may be obtained. When severe fading occurs on a maximum of three frequency points, and no valid measurement value can be obtained, the complete frequency baseline coverage can still be ensured.

For example, for a 5G NR signal whose frequency band range is FR2, maximum total available bandwidth is approximately 400 MHz. For example, a subcarrier spacing is 120 kHz, and the maximum available bandwidth is 399.96 MHz. A total quantity of subcarriers is 3333, a quantity of subcarriers that may be used for sensing cannot be greater than 150, that is, the total quantity N of available frequency domain resources is equal to 150. If the unambiguous ranging distance rₘₐₓ is equal to 390 m, it may be determined, according to a formula

$$\vert {b}_{min \_ thresh} \vert = \frac{c}{{r}_{max}} ,$$

that the minimum frequency baseline threshold is 769.2 kHz. If the ranging resolution Δr is equal to 0.8 m, it may be determined, according to a formula

$$\vert {b}_{max \_ thresh} \vert = \frac{c}{Δ r} ,$$

that the required maximum frequency baseline threshold is 375 MHz. A maximum baseline length and a minimum baseline length each are set to an integer multiple of the subcarrier spacing. The maximum baseline length should be greater than the maximum baseline length threshold, and is set to ┌375 MHz/120 KHz┐*120 KHz=375 MHz, where ┌a┐ indicates that a rounding-up operation is performed on a number a. The minimum baseline length should be less than the minimum baseline length threshold, and is set to └769.2 KHz/120 KHz┘*120 KHz=720 KHz, where └a┘ indicates that a rounding-down operation is performed on a. The maximum baseline length should be an integer multiple of the minimum baseline length. Therefore, the maximum baseline length is further adjusted to ┌375 MHz/720 KHz┐*720 KHz=375.12 MHz. A subcarrier set [symbol] ={fₙ=fₘᵢₙ+(n−1)*720 KHz|n∈[1,523]} is obtained based on the minimum baseline length and the maximum baseline length. After the sensed subcarrier set [symbol] is determined, a multi-level redundancy structure is further obtained through design in a nesting manner, and the parameters N1, N2, and P are determined. N₂(N1+1)+P≥|bₘₐₓ|/|bₘᵢₙ|=522 and N₁+PN₂≤N=150 need to be satisfied, and a largest value of P is obtained through optimized design. After the optimized design, the largest value of P may be 11. N1=72, N2=7, and P=11. Under a given condition, an 11-level redundancy frequency baseline distribution may be obtained. When severe fading occurs on a maximum of 10 frequency points, and no valid measurement value can be obtained, the complete frequency baseline coverage can still be ensured.

In a second possible implementation, shifting is performed based on a solution of the complete baseline coverage. A specific manner is as follows.

F is a frequency set that meets the sensing requirement parameter and the first condition.

The frequency set F is shifted by p, which is denoted as Fₚ. The set F is separately shifted by 1, 2, . . . , and P−1, to obtain F₁, F₂, . . . , and F_{P-1}, and

$${F}^{′} = {U}_{p = 0}^{P - 1} {F}_{p}$$

is obtained by using a union set of all sets, where F₀ indicates that no shifting is performed, and F₀=F. F′ meets P-level redundancy.

In a third possible implementation, an evenly-distributed frequency domain resource set is constructed. Specifically, the frequency domain resource set S=[1, 2, . . . , K+1] is selected based on a maximum frequency baseline length K, to be specific, frequency domain resource set S is evenly distributed, and the maximum frequency baseline length of the frequency domain resources S is K. In this case, a relationship between a quantity of baseline redundancy times and a baseline length is pₖ+|bₖ|=K+1, where pₖ indicates a quantity of redundancy times of a k^{th} frequency baseline, and |bₖ| indicates a length of the k^{th} frequency baseline. That is, S meets K+1-level redundancy. When P<K+1, the P-level redundancy is met.

In a fourth possible implementation, P-level redundancy is determined through extraction one by one based on a solution of evenness. A specific manner is as follows.

Step 1: Select a frequency domain resource set S=[1, 2, . . . , K+1] based on a maximum frequency baseline length K, to be specific, domain resources S are evenly distributed, and the maximum frequency baseline length of the frequency domain resource set S is K. In this case, a relationship between a quantity of baseline redundancy times and a baseline length is pₖ+|bₖ|=K+1, where pₖ indicates a quantity of redundancy times of a k^{th} frequency baseline, and |bₖ| indicates a length of the k^{th} frequency baseline.

Step 2: Extract a frequency resource from the frequency domain resource set S, for example, extract the k^{th} frequency resource, and check whether coverage of a frequency baseline formed by a remaining frequency resource set S′ meets a requirement of the P-level redundancy distribution.

Step 3: In step 2, if the requirement of the P-level redundancy distribution can still be met after extraction, repeat step 2 to further perform extraction; or if the requirement of the P-level redundancy distribution cannot be met after extraction, change a frequency position after extraction, and check whether the requirement of the P-level redundancy distribution is met, and if all frequency resources in S′ are changed through extraction but the requirement of the P-level redundancy distribution still cannot be met, stop the extraction.

In this implementation, when the P-level redundancy is ensured, a quantity of required subcarriers is less than that in the third manner, to effectively save overheads of the subcarriers in frequency domain. This avoids that excessive communication resources are occupied and communication performance is affected. For a specific implementation of determining the first frequency domain resource by the first communication apparatus in step 201, refer to related descriptions in FIG. 2C and FIG. 2D below. Details are not described herein.

202: The first communication apparatus sends the sensing signal on the first frequency domain resource.

For example, the first frequency domain resource includes the frequency point 0, the frequency point 2, the frequency point 4, and the frequency point 6. The frequency of the frequency point 0 is f₀, the frequency of the frequency point 2 is f₂, the frequency of the frequency point 4 is f₄, and the frequency of the frequency point 6 is f₆. In this case, the first communication apparatus separately sends the sensing signal on frequency points whose frequencies are respectively f₀, f₂, f₄, and f₆.

For example, the first frequency domain resource includes the frequency band from the frequency f₀ to the frequency f₆. The first communication apparatus is a radar device, and the radar device sends a frequency-modulated continuous wave (FMCW) in the frequency band from the frequency f₀ to the frequency f₆.

In this embodiment of this application, in the embodiment shown in FIG. 2A, before the second communication apparatus senses and measures the sensing signal, the second communication apparatus enables a sensing function.

Optionally, the second communication apparatus may periodically enable the sensing function or always enable the sensing function, or the first communication apparatus or the third communication apparatus may trigger the second communication apparatus to enable the sensing function. Optionally, the embodiment shown in FIG. 2A further includes step 202a. Step 202a may be performed before step 202.

202a: The first communication apparatus sends a trigger instruction to the second communication apparatus.

The trigger instruction is used to trigger the second communication apparatus to enable the sensing function.

Specifically, before sending the sensing signal, the first communication apparatus may trigger, by using the trigger instruction, the second communication apparatus to enable the sensing function, to help the second communication apparatus receive the sensing signal, and sense and measure the sensing signal.

Optionally, the trigger instruction includes an RRC instruction or a DCI instruction.

A manner in which the third communication apparatus triggers the second communication apparatus to enable the sensing function is similar to that in step 202a. Details are not described herein again.

In this embodiment, if the first communication apparatus serves as the transmitter and the receiver of the sensing signal, optionally, the embodiment shown in FIG. 2A further includes step 203 and step 204. Step 203 and step 204 may be performed after step 202.

203: The first communication apparatus receives the reflected sensing signal on the first frequency domain resource.

For example, as shown in FIG. 1A, the network device 1 separately sends the sensing signal on the frequency points whose frequencies are respectively f₀, f₂, f₄, and f₆. The sensing signal is reflected to the network device 1 through a vehicle (that is, a sensed target) in the ambient environment. The network device 1 receives, on the frequency points whose frequencies are respectively f₀, f₂, f₄, and f₆, the sensing signal reflected through the sensed target.

For example, the first communication apparatus is the radar device. The radar device sends the frequency-modulated continuous wave in the frequency band from the frequency f₀ to the frequency f₆. The sensing signal is reflected back to the radar device through the sensed target in the ambient environment. The radar device receives the frequency-modulated continuous wave in the frequency band from the frequency f₀ to the frequency f₆.

204: The first communication apparatus senses and measures the sensing signal, to obtain a sensing result.

In this embodiment, optionally, the sensing result includes a distance between the first communication apparatus and the sensed target, a quantity of motions and a position that are of the sensed target, and the like.

For example, as shown in FIG. 1A, the network device 1 transmits sensing signals on two subcarriers whose frequency points are respectively 3.5 GHz and 3.501 GHZ, and initial phases of the sensing signals on the two subcarriers at a baseline 1 are both 0. The vehicle is the sensed target. Phase changes caused by the sensing signals on the two subcarriers whose frequency points are respectively 3.5 GHZ and 3.501 GHz are respectively 700π and 700.2π. In addition, if a difference value between the phase changes of the two subcarriers is Δϕ₂₁=0.2π, the network device 1 may determine that

$$τ = \frac{{Δϕ}_{21}}{( 2 π ( {f}_{2} - {f}_{1} ) )} = 0 \text{.2} π / ( 2 π * 1 {0}^{6} ) ns = 100 ns ,$$

where f₁=3.501 GHz, and f₂=3.5 GHz. In this case, a distance between the network device 1 and the vehicle is R1=cτ/2=15 m, where c is the propagation speed of the light under the atmospheric standard conditions.

A motion rate of the vehicle relative to the network device 1 may be determined based on a change of the distance r between the network device 1 and the vehicle relative to time. A position of the vehicle may be obtained by jointly sensing and ranging the vehicle through a plurality of network devices. For example, each of the plurality of network devices can obtain a distance between each network device and the vehicle. In this case, coordinates of the vehicle, that is, the position of the vehicle, in three-dimensional space may be obtained by combining ranging results of four network devices.

In this embodiment, if the first communication apparatus serves as the transmitter of the sensing signal, and the second communication apparatus serves as the receiver of the sensing signal, optionally, the embodiment shown in FIG. 2A further includes step 205 to step 207. Step 205 to step 207 may be performed after step 202.

205: The second communication apparatus determines the first frequency domain resource.

In step 205, the second communication apparatus may determine the first frequency domain resource based on the sensing requirement parameter; or the second communication apparatus receives first information from the first communication apparatus, and determines the first frequency domain resource based on the first information. For details, step 205 is similar to step 201. For details, refer to the related descriptions of step 201. Details are not described herein again.

206: The second communication apparatus receives the sensing signal on the first frequency domain resource.

For example, the first frequency domain resource includes the frequency point 0, the frequency point 2, the frequency point 4, and the frequency point 6. The frequency of the frequency point 0 is f₀, the frequency of the frequency point 2 is f₂, the frequency of the frequency point 4 is f₄, and the frequency of the frequency point 6 is f₆. In this case, the second communication apparatus separately receives the sensing signal on the frequency points whose frequencies are respectively f₀, f₂, f₄, and f₆.

207: The second communication apparatus senses and measures the sensing signal, to obtain a sensing result.

For example, as shown in FIG. 1B, the network device 1 transmits signals on three subcarriers whose frequencies are respectively 3.5 GHZ, 3.501 GHZ, and 3.503 GHz, and initial phases of the sensing signals on the three subcarriers at the network device 1 are all 0. The vehicle is the sensed target. A sum of the distance between the network device 1 and the vehicle and the distance between the vehicle and the terminal device is R1+R2. In this case, the sensing signal arrives at the vehicle after R1 propagation, and then returns to the terminal device after R2 propagation.

A subcarrier whose frequency is 3.5 GHz is referred to as a subcarrier 1, and f₁=3.5 GHz. A subcarrier whose frequency is 3.501 GHz is referred to as a subcarrier 2, and f₂=3.501 GHz. A subcarrier whose frequency is 3.503 GHz is referred to as a subcarrier 3, and f₃=3.503 GHz.

Phase changes caused by the sensing signals on the subcarrier 1, the subcarrier 2, and the subcarrier 3 are respectively 700.01π, 700.19π, and 700.61π. In addition, a difference value between a phase change on the subcarrier 1 and a phase change on the subcarrier 2 is Δϕ21=0.18T. In this case, the network device 1 may determine that

$${τ}_{1} = \frac{{Δϕ}_{21}}{( 2 π ( {f}_{2} - {f}_{1} ) )} = 0.18 π / ( 2 π * 1 {0}^{6} ) ns = 90 ns .$$

In this case, a distance from the network device 1 to the vehicle and then from the vehicle to the terminal device is obtained through calculation: R1+R2=cτ₁=27 m.

A difference value between the phase change of the sensing signal on the subcarrier 2 and the phase change of the sensing signal on the subcarrier 3 is Δϕ32=0.42π. In this case, the network device 1 may determine that

$${τ}_{2} = \frac{{Δϕ}_{32}}{( 2 π ( {f}_{3} - {f}_{2} ) )} = 0.42 π / ( 2 π * 1 {0}^{6} ) ns = 105 ns .$$

In this case, a distance from the network device 1 to the vehicle and then from the vehicle to the terminal device is obtained through calculation: R1+R2=cτ₂=31.5 m.

A difference value between the phase change of the sensing signal on the subcarrier 1 and the phase change of the sensing signal on the subcarrier 3 is Δϕ₃₁=0.6π. In this case, the network device 1 may determine that

$${τ}_{3} = \frac{{Δϕ}_{31}}{( 2 π ( {f}_{3} - {f}_{1} ) )} = 0 \text{.6} π / ( 2 π * 1 {0}^{6} ) ns = 100 ns .$$

In this case, a distance from the network device 1 to the vehicle and then from the vehicle to the terminal device is obtained through calculation: R1+R2=cτ₃=30 m, where c is the propagation speed of the light under the standard atmospheric conditions.

It can be learned from the foregoing calculation results that, results obtained through calculation by using different subcarriers are different. This is mainly because noise exists in an actual measurement process, and consequently, measurement deviations exist. Therefore, the network device 1 may average measurement results of different subcarriers, to obtain a final result, to reduce impact of measured noise. In this case, the sum of the distance from the network device 1 to the vehicle and the distance from the vehicle to the terminal device is (27 m+31.5 m+30 m)/3=29.5 m.

It should be noted that the network device 1 or the terminal device may determine the distance from the network device 1 to the vehicle and then from the vehicle to the terminal device with reference to a specific application scenario. For example, in a vehicle positioning scenario with a high security requirement, the terminal device is a vehicle 2. In this case, the network device 1 or the vehicle 2 may use the distance of 27 m from the network device 1 to the vehicle and then from the vehicle to the vehicle 2 as a final result obtained through measurement. This can prevent a driving safety problem between the vehicle 1 and the vehicle 2 caused by a measurement deviation.

The distance between the network device 1 and the vehicle, the distance between the vehicle and the terminal device, and the position of the vehicle may be obtained through joint ranging between a plurality of network devices and the terminal device. For example, the terminal device may obtain the distance from the terminal device to the vehicle and a distance from the vehicle to each of the plurality of network devices. In this case, the coordinates of the vehicle, that is, the position of the vehicle, in the three-dimensional space may be obtained by combining the ranging results of the terminal device for the four network devices. A speed of the vehicle may be obtained based on a change of the position of the vehicle relative to time.

In this embodiment of this application, the first communication apparatus determines the first frequency domain resource, where the first frequency domain resource meets the frequency baseline P-level redundancy distribution. Then, the first communication apparatus sends the sensing signal on the first frequency domain resource. It can be learned from this that in technical solutions of this application, the frequency baseline missing caused by the channel frequency-selective fading can be reduced, the interference can be reduced, and sensing performance can be improved. In addition, the measured signal-to-noise ratio may be further improved.

In this embodiment of this application, the first communication apparatus determines the first frequency domain resource in a plurality of manners. The following shows three possible implementations. Details are respectively described with reference to FIG. 2C, FIG. 2D, and FIG. 2E.

The following describes a first implementation with reference to an embodiment shown in FIG. 2C.

Refer to FIG. 2C. Step 201 specifically includes step 201a and step 201b.

Step 201a: The first communication apparatus obtains the sensing requirement parameter.

Specifically, the first communication apparatus obtains the sensing requirement parameter in a plurality of manners. The following shows two possible implementations.

Implementation 1: The first communication apparatus determines the sensing requirement parameter based on a sensing requirement.

In a possible implementation, the sensing requirement includes a requirement for performing sensing and ranging by using the sensing signal.

For example, as shown in FIG. 1B, the network device 1 determines the unambiguous ranging distance, the ranging resolution, and the like based on the sensing requirement.

Implementation 2: The first communication apparatus receives the sensing requirement parameter from the second communication apparatus or the third communication apparatus.

For example, as shown in FIG. 1B, the first communication apparatus is the network device 1, and the second communication apparatus is the terminal device. The terminal device may send a sensing request and a corresponding sensing requirement parameter to the network device 1, so that the terminal device senses the ambient environment by using the sensing signal. Correspondingly, the network device 1 receives the sensing request and the sensing requirement parameter from the terminal device. The sensing request is used to request the network device 1 to send the sensing signal.

For example, as shown in FIG. 1F, the first communication apparatus is the network device 1, the second communication apparatus is a network device 2, and the third communication apparatus is a network device 3. The network device 3 may send the sensing requirement parameter to the network device 1, and send a trigger instruction to the network device 2. The trigger instruction is used to trigger the network device 2 to enable a sensing function.

Step 201b: The first communication apparatus determines the first frequency domain resource based on the sensing requirement parameter.

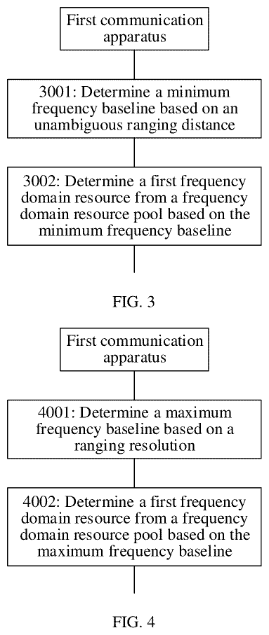

For specific descriptions of step 201b, refer to detailed descriptions in embodiments shown in FIG. 3 to FIG. 5 below. Details are not described herein.

Based on the implementations of step 201a and step 201b, optionally, the embodiment shown in FIG. 2C further includes step 201c. Step 201c is performed after step 201b.

Refer to FIG. 2C. Step 201c is specifically that the first communication apparatus sends the first information to the second communication apparatus. Correspondingly, the second communication apparatus receives the first information from the first communication apparatus.

The first information indicates a frequency domain position of the first frequency domain resource.

Specifically, the first communication apparatus indicates the frequency domain position of the first frequency domain resource to the second communication apparatus by using the first information.

In this embodiment, there are a plurality of indication manners of the first information. The following shows three possible indication manners.

Indication manner 1: The first information includes a frequency domain resource construction parameter.

The frequency domain resource construction parameter is used to construct the first frequency domain resource.

In the indication manner, the first communication apparatus and the second communication apparatus preset a formula and a required parameter for constructing the first frequency domain resource.

For example, the first frequency domain resource may be expressed as {1, 2, . . . , N1+P, 2*(N1+1), 2*(N1+1)+1, . . . , 2*(N1+1)+P−1, . . . , N2*(N1+1), N2*(N1+1)+1, . . . , N2*(N1+1)+P−1}*|bₘᵢₙ| in the foregoing embodiment. The frequency domain resource construction parameter includes a quantity N1 of frequency domain resources in the first frequency domain resource set, a quantity N2 of frequency domain resources in the second frequency domain resource set, a quantity of redundancy distribution times P, and a minimum frequency baseline length |bₘᵢₙ|. The first frequency domain resource may be constructed by substituting the frequency domain resource construction parameter into the foregoing formula. In the indication manner, a data amount of the first information can be saved.

Indication manner 2: The first information includes the frequency domain position of the first frequency domain resource.

In the indication manner, the first information specifically includes specific position information of the first frequency domain resource. For example, the first frequency domain resource includes the frequency point 1, the frequency point 2, and a frequency point 3. The first information includes frequencies respectively corresponding to the frequency point 1, the frequency point 2, and the frequency point 3.

Indication manner 3: The first information includes a sensing quality index (SQI).

The sensing quality index indicates the frequency domain position of the first frequency domain resource.

In the indication manner, a table is preconfigured in the first communication apparatus and the second communication apparatus. The table indicates a mapping relationship between the sensing quality index and a frequency domain resource. In the table, the sensing quality index has a corresponding frequency domain resource.

For example, as shown in Table 1, the following uses an example in which the first frequency domain resource includes a frequency point combination for description.

TABLE 1

| Sensing | Frequencies respectively corresponding to the frequency |
|---|---|
| quality index | points included in the frequency point combination |
| 0 | f₀, f₂, f₄, and f₆ |
| 1 | f₀, f₁, f₃, and f₄ |
| 2 | f₀, f₂, f₄, f₆, and f₁₂ |
| 3 | f₀, f₁, and f₄ |
| . . . | . . . |

fₓ indicates a frequency of a frequency point x. x is a positive integer belonging to [0, M], and M is a positive integer. A value of M is a total quantity of frequency points included in the frequency domain resource pool.

In this embodiment, optionally, the first information is carried in RRC signaling or DCI signaling.

In this embodiment, optionally, after receiving the first information from the first communication apparatus, the second communication apparatus feeds back a first response message to the first communication apparatus, to notify the first communication apparatus that the second communication apparatus successfully receives the first information. Optionally, the embodiment shown in FIG. 2C further includes step 201d. For details, refer to FIG. 2C. Step 201d may be performed after step 201c.

Step 201d: The second communication apparatus sends the first response message to the first communication apparatus. Correspondingly, the first communication apparatus receives the first response message from the second communication apparatus.

The first response message is used to notify the first communication apparatus that the second communication apparatus successfully receives the first information.

The following describes a second implementation with reference to FIG. 2D.

FIG. 2D is a diagram of another embodiment of a communication method according to an embodiment of this application. It is assumed that the first communication apparatus serves as the transmitter of the sensing signal, and the second communication apparatus serves as the receiver of the sensing signal. Refer to FIG. 2D. Optionally, step 201 specifically includes step 201d and step 201e.

Step 201d: The second communication apparatus sends second information to the first communication apparatus, and correspondingly, the first communication apparatus receives the second information from the second communication apparatus.

The second information indicates the frequency domain position of the first frequency domain resource.

In this implementation, the second communication apparatus determines the first frequency domain resource, and then notifies the first communication apparatus of the frequency domain position of the first frequency domain resource by using the second information. A manner in which the second communication apparatus determines the first frequency domain resource is similar to a process in which the first communication apparatus determines the first frequency domain resource in step 201b. For details, refer to the related descriptions of determining the first frequency domain resource by the first communication apparatus in step 201b in FIG. 2C. Details are not described herein again.

Indication manners of the second information are similar to the indication manners of the first information. For details, refer to the related descriptions of the indication manners of the first information. Details are not described herein again.

In this embodiment, optionally, the second information is carried in RRC signaling or DCI signaling.

Step 201e: The first communication apparatus determines the first frequency domain resource based on the second information.

Optionally, after the first communication apparatus receives the second information, the embodiment shown in FIG. 2D further includes step 201f. Step 201f is performed after step 201e.

201f: The first communication apparatus sends a second response message to the second communication apparatus. Correspondingly, the second communication apparatus receives the second response message from the first communication apparatus.

The second response message is used to notify the second communication apparatus that the first communication apparatus successfully receives the second information.

In this embodiment of this application, the first communication apparatus determines the first frequency domain resource based on the sensing requirement parameter in step 201b in a plurality of manners. The following shows two possible implementations.

Implementation 1: The first communication apparatus determines the first frequency domain resource based on the sensing requirement parameter and a first mapping relationship.

The first mapping relationship includes a mapping relationship between the sensing requirement parameter and a frequency domain resource.

Optionally, the first mapping relationship may be indicated by using a table. For example, as shown in Table 2, an example in which the first frequency domain resource includes the frequency point combination, and the sensing requirement parameter includes the unambiguous ranging distance and the ranging resolution is used for description in Table 2.

TABLE 2

| Unambiguous | Ranging | Frequencies (Hz) respectively corresponding |
|---|---|---|
| ranging | resolution | to the frequency points included in the |
| distance (m) | (m) | frequency point combination |
| 90 | 10 | {f(j)\|f(j) = 3.5 * 10⁹ + j * 15 * 10³, j = |
| | | 0, 200, 800, 1400, 1800} |
| 130 | 10 | {f(j)\|f(j) = 3.5 * 10⁹ + j * 15 * 10³, j = |
| | | 0, 200, 400, 1200, 2000, 2600} |
| 90 | 5 | {f(j)\|f(j) = 3.5 * 10⁹ + j * 15 * 10³, j = |
| | | 0, 100, 200, 600, 1000, 1400, 1700, 1800} |
| 130 | 5 | {f(j)\|f(j) = 3.5 * 10⁹ + j * 15 * 10³, j = |
| | | 0, 100, 200, 1100, 1500, 1800, 2100, 2300, |
| | | 2600} |

For example, in the sensing requirement parameter, the unambiguous ranging distance is 90, and the ranging resolution is 10. In this case, the first communication apparatus can learn, according to Table 2, that the frequency point combination is determined as {f(j)|f(j)=3.5*10⁹+j*15*10³, j=0, 200, 800, 1400, 1800}.

It should be noted that, when the unambiguous ranging distance and the ranging resolution in the sensing requirement parameter do not match any group of an unambiguous ranging distance and a ranging resolution in Table 2, the first communication apparatus may select, as the first frequency domain resource, a frequency point combination corresponding to a group of an unambiguous ranging distance and a ranging resolution that are similar to the unambiguous ranging distance and the ranging resolution in the sensing requirement parameter.

For example, in the sensing requirement parameter, if the unambiguous ranging distance is 89 and the ranging resolution is 11, the first communication apparatus may select, as the first frequency domain resource, the frequency point combination corresponding to a case in which the unambiguous ranging distance is 90 and the ranging resolution is 10 in Table 2.

It can be learned from Table 2 that, when requirements on the ranging resolution are the same, a larger unambiguous ranging distance indicates a larger quantity of frequency points included in the frequency point combination, to meet requirements on the unambiguous ranging distance.

For example, as shown in Table 2, the unambiguous ranging distance is 90, the ranging resolution is 10, and a corresponding frequency point combination is {f(j)|f(j)=3.5*10⁹+j**10³, j=0, 200, 800, 1400, 1800}. The unambiguous ranging distance is 130, the ranging resolution is 10, and a corresponding frequency point combination is {f(j)|f(j)=3.5*10⁹+j**10³, j=0, 200, 400, 1200, 2000, 2600}. A quantity of frequency points included in the frequency point combination {f(j)|f( ) 3.5*10⁹+j*15*10³, j=0, 200, 400, 1200, 2000, 2600} is clearly greater than a quantity of frequency points included in the frequency point combination {(f)|f(j)=3.5*10⁹+j*15*10³, j=0, 200, 800, 1400, 1800}.

It can be learned from Table 2 that, when values of the unambiguous ranging distance in the sensing requirement parameter are the same, a lower ranging resolution indicates a larger quantity of frequency points included in the frequency point combination, to meet the requirements on the ranging resolution.

For example, as shown in Table 2, the unambiguous ranging distance is 90, the ranging resolution is 10, and the corresponding frequency point combination is {f(j)|f(j)=3.5*10⁹+j*15*10³, j=0, 200, 800, 1400, 1800}.

The unambiguous ranging distance is 90, the ranging resolution is 5, and a corresponding frequency point combination is {f(j)|f(j)=3.5*10⁹+j*15*10³, j=0, 100, 200, 600, 1000, 1400, 1700, 1800}. It can be learned from this that the quantity of frequency points included in the frequency point combination {f(j)|f(j)=3.5*10⁹+j*15*10³, j=0, 100, 200, 600, 1000, 1400, 1700, 1800} is clearly greater than the quantity of frequency points included in the frequency point combination {f(j)|f(j)=3.5*10⁹+j*15*10³, j=0, 200, 800, 1400, 1800}.

It should be noted that Table 2 may be preconfigured on the first communication apparatus or may be sent by another communication apparatus to the first communication apparatus, or the first communication apparatus determines, based on Implementation 2, a frequency point combination corresponding to each sensing requirement parameter by using a plurality of sensing requirement parameters, and then generates and stores Table 2.

In Implementation 1, the first communication apparatus determines the first frequency domain resource in a table lookup manner. In this way, time consumed by the first communication apparatus to determine the first frequency domain resource is short, and computing resources can be effectively saved.

Implementation 2: The first communication apparatus determines the first frequency domain resource from the frequency domain resource pool based on content included in the sensing requirement parameter.

FIG. 2E is a diagram of another embodiment of a communication method according to an embodiment of this application. Optionally, step 201 specifically includes step 201g and step 201h.

Step 201g: The first communication apparatus obtains a frequency response amplitude.

Specifically, the first communication apparatus obtains the frequency response amplitude in a plurality of manners. The following shows two possible implementations.

Implementation 1: The first communication apparatus obtains the frequency response amplitude by obtaining the channel state information (CSI).

For example, as shown in FIG. 1B, the first communication apparatus is the network device 1, and the second communication apparatus is the terminal device. The terminal device may send the CSI to the network device 1. Correspondingly, the network device 1 receives the CSI. The CSI includes frequency response information, and the frequency response amplitude may be obtained by using the CSI.

Implementation 2: The first communication apparatus obtains a frequency response amplitude by testing the sensing signal in frequency domain in the frequency domain resource pool.

For example, as shown in FIG. 1B, the first communication apparatus is the network device 1, and the second communication apparatus is the terminal device. The network device 1 may send the sensing signal to the terminal device in frequency domain in the frequency domain resource pool, and the terminal device receives and feeds back a frequency response. Alternatively, the terminal device may send the sensing signal in frequency domain in the frequency domain resource pool, and the network device 1 receives and obtains a frequency response.

Step 201h: The first communication apparatus determines the first frequency domain resource based on the frequency response amplitude. A larger frequency response amplitude difference indicates a higher frequency fading degree and a larger required value of P.

In a possible implementation, a frequency response amplitude difference may be indicated by any one of the following three frequency response amplitude parameters:
1. ratio α of a maximum value to a minimum value of the frequency response amplitude, where a larger value of α indicates a larger frequency response amplitude difference;
2. ratio β of a variance to an average value square of the frequency response amplitude, where a larger value of β indicates a larger frequency response amplitude difference; and
3. ratio γ of a standard deviation to an amplitude response average value of the frequency response amplitude, where a larger value of γ indicates a larger frequency response amplitude difference.

For example, for a correspondence between a frequency response amplitude parameter and the value of P, refer to Table 3A, Table 3B, and Table 3C.

TABLE 3A

| α | Quantity P of redundancy layers |
|---|---|
| ≤10 | 1 |
| >10 | 2 |
| >15 | 3 |
| >20 | 4 |
| >25 | 5 |

TABLE 3B

| β | Quantity P of redundancy layers |
|---|---|
| ≤1 | 1 |
| >1 | 2 |
| >4 | 3 |
| >9 | 4 |
| >16 | 5 |

TABLE 3C

| γ | Quantity P of redundancy layers |
|---|---|
| ≤1 | 1 |
| >1 | 2 |
| >2 | 3 |
| >3 | 4 |
| >4 | 5 |

It may be understood that, when the quantity P of redundancy layers is equal to 1, that is, there is no redundancy, it may be considered that when P=1, redundancy is disabled; or when P>1, redundancy is enabled.

After determining the value of P, the first communication apparatus selects the first frequency domain resource from the frequency domain resource pool, where the first frequency domain resource meets the frequency baseline P-level redundancy distribution.

This embodiment may be combined with the embodiment in FIG. 2C, and the first frequency domain resource may be determined by obtaining the sensing requirement parameter and/or the frequency response amplitude.

I. With reference to FIG. 3, the following describes a method for determining the first frequency domain resource from the frequency domain resource pool by the first communication apparatus based on the sensing requirement parameter when the sensing requirement parameter includes the unambiguous ranging distance. Refer to FIG. 3. Step 201b specifically includes step 3001 and step 3002.

3001: The first communication apparatus determines the minimum frequency baseline threshold based on the unambiguous ranging distance.

Specifically, if the unambiguous ranging distance is rₘₐₓ, the first communication apparatus may determine that the minimum frequency baseline threshold is

$$\vert {b}_{min \_ thresh} \vert = \frac{c}{{r}_{max}} .$$

The following describes a specific principle of step 3001. It is assumed that the first communication apparatus performs sensing and ranging by using two subcarriers. Frequencies of the two subcarriers are respectively f₁ and f₂. The first communication apparatus separately sends sensing signals on the two subcarriers, and the sensing signals pass through a target and are reflected to the second communication apparatus. The second communication apparatus receives the reflected sensing signals. A delay of the sensing signal passing through an entire path is t. It is assumed that initial phases of the sensing signals of the two subcarriers at the first communication apparatus are both 0. In this case, after the delay t, phase changes on the two subcarriers are respectively 2πf₁τ and 2πf₂τ.

A difference value between the phase changes of the two subcarriers may be expressed as Δϕ₂₁=2π(f₂−f₁)τ.

The second communication apparatus may measure the phase changes of the two subcarriers, and obtain the difference value Δϕ21 between the phase changes of the two subcarriers. In this case, τ=Δϕ₂₁/(2π(f₂−f₁)), and a sum of a distance between the first communication apparatus and the target and a distance between the target and the second communication apparatus is r=cτ=c*Δϕ₂₁/(2π(f₂−f₁)), where c is the propagation speed of the light under the standard atmospheric conditions.

It can be learned, according to a formula τ=Δϕ₂₁/(2π(f₂−f₁)), that a smaller frequency baseline indicates smaller |f₂−f₁|. In this case, in A Δϕ₂₁=2π(f₂−f₁)τ, it is more not easy that 2π is exceeded with a change of t (which is because a phase is ambiguous if Δϕ₂₁ exceeds 2π, resulting in ambiguous ranging). Therefore, 2π(f₂−f₁)≤2π, and

$$τ \leq \frac{1}{( {f}_{2} - {f}_{1} )}$$

required. In this case, a smaller |f₂−f₁| indicates a larger t and a larger unambiguous distance. Therefore, in step 3001, the first communication apparatus may determine a minimum frequency baseline of the frequency point combination with reference to the unambiguous ranging distance.

It should be noted that, the initial phases of the sensing signals of the two subcarriers at the first communication apparatus may alternatively not be 0. The foregoing is merely an example, and is not a limitation on the technical solutions of this application.

The phase is unambiguous if Δϕ₂₁ exceeds 2π, resulting in the ambiguous ranging. For example, it is assumed that a real value of Δϕ₂₁ is 2kπ+π/3, and an actual value obtained through measurement is π/3. A delay 1/(6(f₂−f₁)) is determined based on the actual value obtained through measurement, and an actual delay is (k+1/6)/(f₂−f₁). Therefore, a maximum value of the difference value Δϕ21 between the phase changes of the subcarriers is 2π, a corresponding delay is τₘₐₓ=1/(f₂−f₁), and corresponding Rₘₐₓ=cτₘₐₓ=c(f₂−f₁). In this case, Rₘₐₓ is referred to as a maximum unambiguous ranging distance. In other words, if a sum of a distance between the first communication apparatus and the sensed target and a distance between the second communication apparatus and the sensed target is less than Rₘₐₓ, the ambiguous ranging does not occur. If a sum of a distance between the first communication apparatus and the sensed target and a distance between the second communication apparatus and the sensed target is greater than or equal to Rₘₐₓ, the ambiguous ranging occurs.

3002: The first communication apparatus determines the first frequency domain resource from the frequency domain resource pool based on the minimum frequency baseline.

Herein, an example in which the first frequency domain resource includes the frequency point combination is used for description. Specifically, the first communication apparatus selects a frequency point from the frequency points included in the frequency domain resource pool, to obtain the frequency point combination. The frequency point combination meets the minimum frequency baseline. In other words, if the frequency baseline formed by the frequency point combination includes a frequency baseline whose length is less than or equal to |b_{min_thresh}|, it may be considered that the frequency point combination meets the minimum frequency baseline threshold.

In step 3002, optionally, the first communication apparatus may determine the first frequency domain resource in the following manners.

In a possible implementation, the first communication apparatus determines, from the frequency domain resource pool according to an exhaustive method, a plurality of frequency point combinations that meet the minimum frequency baseline. Then, the first communication apparatus selects one frequency point combination from the plurality of frequency point combinations.

In another possible implementation, the first communication apparatus determines, according to a simulated annealing algorithm (or an ant colony algorithm) and the frequency points included in the frequency domain resource pool, a frequency point combination that meets the minimum frequency baseline.

For example, the frequency point combination includes the frequency point 0, the frequency point 2, the frequency point 4, and the frequency point 6. The frequency points in the frequency point combination are sorted in ascending order of the frequencies. The frequency of the frequency point 0 is f₀, the frequency of the frequency point 2 is f₂, the frequency of the frequency point 4 is f₄, and the frequency of the frequency point 6 is f₆. The unambiguous ranging distance is rₘₐₓ. Therefore, the minimum frequency baseline threshold is

$$\vert {b}_{min \_ thresh} \vert = \frac{c}{{r}_{max}} .$$

In the frequency baseline formed by the two different frequency points in the frequency point combination, the length |f₀−f₂| of the frequency baseline formed by the frequency point 0 and the frequency point 2 is the smallest. If |f₀−f₂| is less than or equal to bₘᵢₙ thresh, it may be understood that the frequency point combination meets the minimum frequency baseline threshold.

It should be noted that the second communication apparatus may alternatively determine the first frequency domain resource based on the embodiment shown in FIG. 3.

II. With reference to FIG. 4, the following describes a method for determining the first frequency domain resource from the frequency domain resource pool by the first communication apparatus based on the sensing requirement parameter when the sensing requirement parameter includes the ranging resolution. Refer to FIG. 4. Step 201b specifically includes step 4001 and step 4002.

4001: The first communication apparatus determines the maximum frequency baseline threshold based on the ranging resolution.

Specifically, if the ranging resolution is Δr, the first communication apparatus may determine that the maximum frequency baseline threshold is

$$\vert {b}_{max \_ thresh} \vert = \frac{c}{Δ r} .$$

The following describes a specific principle of step 4001. It is assumed that the first communication apparatus performs sensing and ranging by using two subcarriers. Frequencies of the two subcarriers are respectively f₁ and f₂. The first communication apparatus separately sends sensing signals on the two subcarriers, and the sensing signals pass through a target and are reflected to the second communication apparatus. The second communication apparatus receives the reflected sensing signals. A delay of the sensing signal passing through an entire path is t. It is assumed that initial phases of the sensing signals of the two subcarriers at the first communication apparatus are both 0. In this case, after the delay t, phase changes on the two subcarriers are respectively 2πf₁τ and 2πf₂τ.

A difference value between the phase changes of the two subcarriers may be expressed as Δϕ₂₁=2π(f₂−f₁)τ.

The second communication apparatus may measure the phase changes of the two subcarriers, and obtain the difference value Δϕ21 between the phase changes of the two subcarriers. In this case, τ=Δϕ₂₁/(2τ(f₂−f₁)), and a sum of a distance between the first communication apparatus and the target and a distance between the target and the second communication apparatus is r=cτ=c*Δϕ₂₁/(2π(f₂−f₁)), where c is the propagation speed of the light under the standard atmospheric conditions.

It can be learned, according to a formula τ=Δϕ₂₁/(2π(f₂−f₁)), that a larger frequency baseline indicates larger |f₂−f₁|. For a same delay t, a larger difference value between phase changes indicates a larger change of Δϕ₂₁=2π(f₂−f₁)τ, and a larger frequency baseline indicates being more sensitive to a change of the delay τ, and being easier to distinguish different delays. Therefore, in step 4001, the first communication apparatus may determine a maximum frequency baseline of the frequency point combination with reference to the ranging resolution.

It should be noted that, the initial phases of the sensing signals of the two subcarriers at the first communication apparatus may not be 0. The foregoing is merely an example, and is not a limitation on the technical solutions of this application.

4002: The first communication apparatus determines the first frequency domain resource from the frequency domain resource pool based on the maximum frequency baseline.

Herein, an example in which the first frequency domain resource includes the frequency point combination is used for description. Specifically, the first communication apparatus selects a frequency point from the frequency points included in the frequency domain resource pool, to obtain the frequency point combination. The frequency point combination meets the maximum frequency baseline threshold. In other words, if the frequency baseline formed by the frequency point combination includes a frequency baseline whose length is greater than or equal to |b_{max_thresh}|, it may be considered that the frequency point combination meets the maximum frequency baseline threshold.

A specific determining manner of step 4002 is similar to the determining manner in step 3002 in the embodiment shown in FIG. 3. For details, refer to the related descriptions of step 3002 in the embodiment shown in FIG. 3. Details are not described herein again.

For example, the frequency point combination includes the frequency point 0, the frequency point 2, the frequency point 4, and the frequency point 6. The frequency points in the frequency point combination are sorted in ascending order of the frequencies. The frequency of the frequency point 0 is f₀, the frequency of the frequency point 2 is f₂, the frequency of the frequency point 4 is f₄, and the frequency of the frequency point 6 is f₆. The ranging resolution is Δr. Therefore, the maximum frequency baseline threshold is

$$\vert {b}_{max \_ thresh} \vert = \frac{c}{Δ r} .$$

In a frequency baseline into which two different frequency points in the frequency point combination are combined, a length of a frequency baseline formed by the frequency point 0 and the frequency point 6 is |f₀−f₆|, and |f₀−f₆| is greater than or equal to b_{max_thresh}. In this case, it may be understood that the frequency point combination meets the maximum frequency baseline threshold.

It should be noted that the second communication apparatus may alternatively determine the first frequency domain resource based on the embodiment shown in FIG. 4.

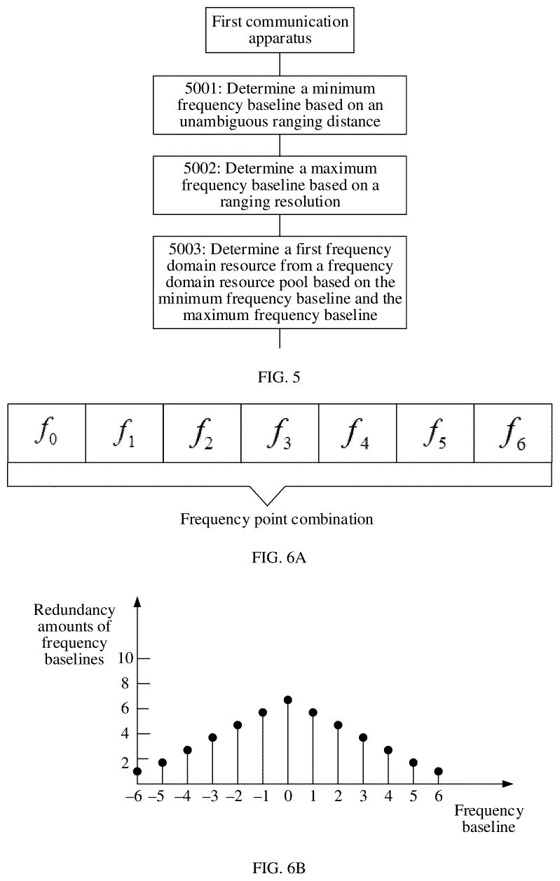

III. With reference to FIG. 5, the following describes a method for determining the first frequency domain resource from the frequency domain resource pool by the first communication apparatus based on the sensing requirement parameter when the sensing requirement parameter includes the unambiguous ranging distance and the ranging resolution. Refer to FIG. 5. Step 201b specifically includes step 5001 to step 5003.

5001: The first communication apparatus determines the minimum frequency baseline threshold based on the unambiguous ranging distance.

5002: The first communication apparatus determines the maximum frequency baseline threshold based on the ranging resolution.

Step 5001 is similar to step 3001 in the embodiment shown in FIG. 3. For details, refer to the related descriptions of step 3001. Details are not described herein again. Step 5002 is similar to step 4001 in the embodiment shown in FIG. 3. For details, refer to the related descriptions of step 4001. Details are not described herein again.

There is no fixed execution sequence between step 5001 and step 5002. Step 5001 may be performed before step 5002; step 5002 may be performed before step 5001; or step 5001 and step 5002 may be simultaneously performed based on a situation. This is not specifically limited in this application.

5003: The first communication apparatus determines the first frequency domain resource from the frequency domain resource pool based on the minimum frequency baseline threshold and the maximum frequency baseline threshold.

Herein, an example in which the first frequency domain resource includes the frequency point combination is used for description. Specifically, the first communication apparatus selects a frequency point from the frequency points included in the frequency domain resource pool, to obtain the frequency point combination. The frequency point combination meets the minimum frequency baseline threshold and maximum frequency baseline threshold. For related descriptions that the frequency point combination meets the minimum frequency baseline threshold and the maximum frequency baseline threshold, refer to the related descriptions in the embodiments shown in FIG. 3 and FIG. 4. Details are not described herein again.

Optionally, the frequency point combination includes the subcarrier combination. The subcarrier combination is a combination including a smallest quantity of subcarriers among subcarrier combinations that meet the maximum baseline length, the minimum baseline length, and the first condition.

Specifically, the first communication apparatus searches for a subcarrier combination in real time by using the maximum frequency baseline length, the minimum frequency baseline length, and the first condition as constraints and using the smallest quantity of subcarriers as an optimization objective, to determine the subcarrier combination. There are a plurality of search algorithms for the subcarrier combination, for example, the exhaustive method, the simulated annealing algorithm, and the ant colony algorithm.

It should be noted that the second communication apparatus may alternatively determine the first frequency domain resource based on the embodiment shown in FIG. 5.

The following describes a first communication apparatus provided in embodiments of this application. FIG. 8 is a diagram of a structure of a first communication apparatus according to an embodiment of this application. The first communication apparatus may be configured to perform the steps performed by the first communication apparatus in the embodiments shown in FIG. 2A, FIG. 2C, FIG. 2D, FIG. 2E, FIG. 3, FIG. 4, and FIG. 5. Refer to the related descriptions in the foregoing method embodiments.

In a possible implementation, the communication apparatus may include modules or units that are in one-to-one correspondence with the methods/operations/steps/actions performed by the first communication apparatus in the foregoing method embodiments. The unit may be implemented by a hardware circuit, software, or a combination of a hardware circuit and software. In a possible implementation, the first communication apparatus may include a processing module 801 and a transceiver module 802. The processing module 801 may be configured to invoke the transceiver module 802 to perform a receiving function and/or a sending function.

The processing module 801 may be configured to determine a first frequency domain resource, where the first frequency domain resource meets a frequency baseline P-level redundancy distribution.

The transceiver module 802 may be configured to send a sensing signal on the first frequency domain resource.

It should be understood that specific processes performed by modules are described in detail in the foregoing method embodiments. For brevity, details are not described herein again.

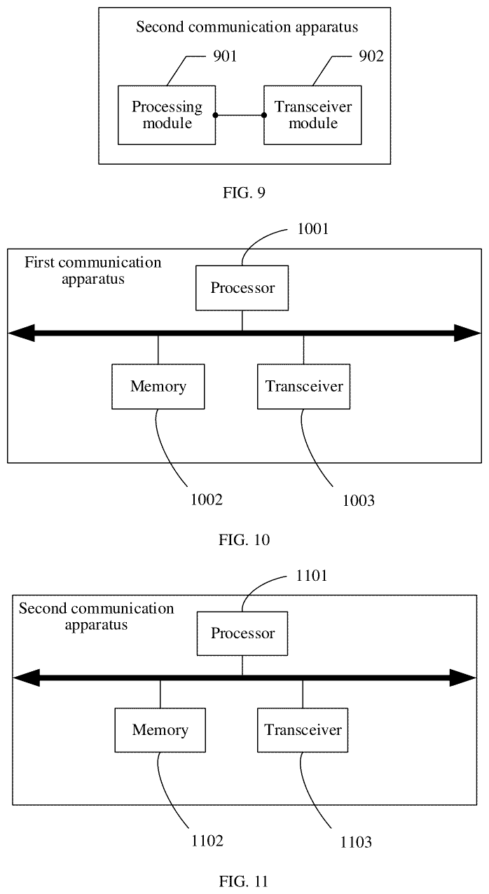

The following describes a second communication apparatus provided in embodiments of this application. FIG. 9 is a diagram of a structure of a second communication apparatus according to an embodiment of this application. The second communication apparatus may be configured to perform the steps performed by the second communication apparatus in the embodiments shown in FIG. 2A, FIG. 2C, FIG. 2D, FIG. 3, FIG. 4, and FIG. 5. Refer to the related descriptions in the foregoing method embodiments.

The second communication apparatus may include a processing module 901 and a transceiver module 902. The processing module 901 may be configured to invoke the transceiver module 902 to perform a receiving function and/or a sending function.

The processing module 901 may be configured to determine a first frequency domain resource, where the first frequency domain resource meets a frequency baseline P-level redundancy distribution.

The transceiver module 902 may be configured to receive a sensing signal from a first communication apparatus on the first frequency domain resource.

The processing module 901 may be further configured to: sense and measure the sensing signal, to obtain a sensing result.

It should be understood that specific processes performed by modules are described in detail in the foregoing method embodiments. For brevity, details are not described herein again.

This application further provides a first communication apparatus. FIG. 10 is a diagram of another structure of the first communication apparatus according to an embodiment of this application. The first communication apparatus may be configured to perform the steps performed by the first communication apparatus in the embodiments shown in FIG. 2A, FIG. 2C, FIG. 2D, FIG. 2E, FIG. 3, FIG. 4, and FIG. 5. Refer to the related descriptions in the foregoing method embodiments.

The first communication apparatus includes a processor 1001 and a transceiver 1003. Optionally, the communication apparatus further includes a memory 1002.

In a possible implementation, the processor 1001, the memory 1002, and the transceiver 1003 are separately connected through a bus, and the memory stores computer instructions.

The processor 1001 in this embodiment may perform an action performed by the processing module 801 shown in FIG. 8. A specific implementation of the processor 1001 is not described. The transceiver 1003 in this embodiment may perform an action performed by the transceiver module 802 in the foregoing embodiment. A specific implementation of the transceiver 1003 is not described.

In the first communication apparatus shown in FIG. 10, the processor 1001 and the memory 1002 may be integrated together, or may be deployed separately. This is not specifically limited in this application.

It should be noted that the memory 1002 shown in FIG. 10 may alternatively be deployed outside the first communication apparatus shown in FIG. 10.

This application further provides a second communication apparatus. FIG. 11 is a diagram of another structure of the second communication apparatus according to an embodiment of this application. The second communication apparatus may be configured to perform the steps performed by the second communication apparatus in the embodiments shown in FIG. 2A, FIG. 2C, and FIG. 2D. Refer to the related descriptions in the foregoing method embodiments.

The second communication apparatus includes a processor 1101 and a transceiver 1103. Optionally, the communication apparatus further includes a memory 1102.

In a possible implementation, the processor 1101, the memory 1102, and the transceiver 1103 are separately connected through a bus, and the memory stores computer instructions.

The processor 1101 in this embodiment may perform an action performed by the processing module 901 shown in FIG. 9. A specific implementation of the processor 1101 is not described. The transceiver 1103 in this embodiment may perform an action performed by the transceiver module 902 in the foregoing embodiment. A specific implementation of the transceiver 1103 is not described.

In the second communication apparatus shown in FIG. 11, the processor 1101 and the memory 1102 may be integrated together, or may be deployed separately. This is not specifically limited in this application.

It should be noted that the memory 1102 shown in FIG. 11 may alternatively be deployed outside the second communication apparatus shown in FIG. 11.

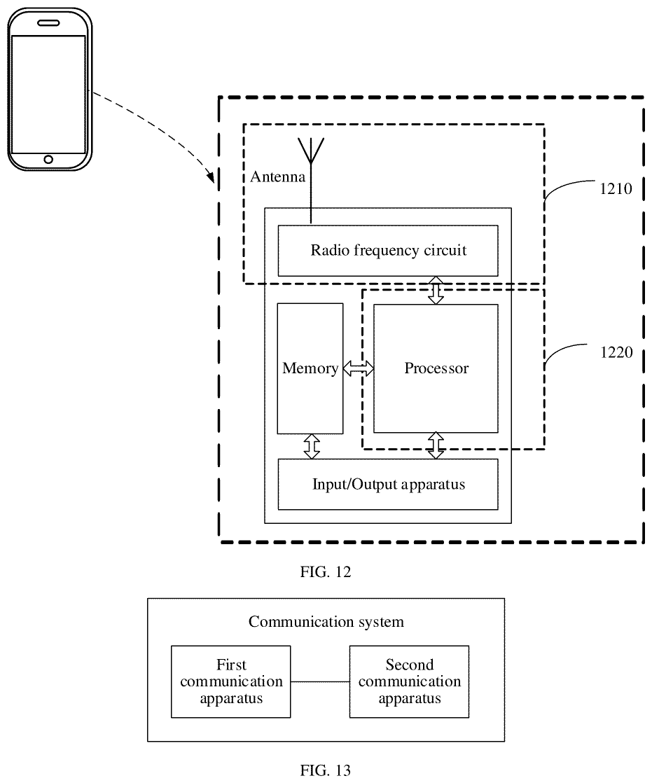

FIG. 12 is a diagram of a possible structure of a first communication apparatus or a second communication apparatus serving as a terminal device below.

FIG. 12 is a diagram of a simplified structure of the terminal device. For ease of understanding and illustration, an example in which the terminal device is a mobile phone is used in FIG. 12. As shown in FIG. 12, the terminal device includes a processor, a memory, a radio frequency circuit, an antenna, and an optional input/output apparatus. The processor is mainly configured to: process a communication protocol and communication data, control the terminal device, execute a software program, process data of the software program, and the like. The memory is mainly configured to store the software program and data. The radio frequency circuit is mainly configured to: perform conversion between a baseband signal and a radio frequency signal, and process the radio frequency signal. The antenna is mainly configured to receive and send a radio frequency signal in a form of an electromagnetic wave. The input/output apparatus, like a touchscreen, a display, or a keyboard, is mainly configured to: receive data input by a user and output data to the user. It should be noted that some types of terminal devices may have no input/output apparatus.

When needing to send data, after performing baseband processing on the to-be-sent data, the processor outputs a baseband signal to the radio frequency circuit; and the radio frequency circuit performs radio frequency processing on the baseband signal and then sends the radio frequency signal to the outside in a form of an electromagnetic wave through the antenna. When data is sent to the terminal device, the radio frequency circuit receives the radio frequency signal through the antenna, converts the radio frequency signal into a baseband signal, and outputs the baseband signal to the processor. The processor converts the baseband signal into data, and processes the data. For ease of description, FIG. 12 shows only one memory and one processor. In an actual terminal device product, there may be one or more processors and one or more memories. The memory may also be referred to as a storage medium, a storage device, or the like. The memory may be disposed independent of the processor, or may be integrated with the processor. This is not limited in this embodiment of this application.

In this embodiment of this application, the antenna and the radio frequency circuit that have a transceiver function may be considered as a transceiver unit of the terminal device, and the processor that has a processing function may be considered as a processing unit of the terminal device. As shown in FIG. 12, the terminal device includes a transceiver unit 1210 and a processing unit 1220. The transceiver unit may also be referred to as a transceiver, a transceiver machine, a transceiver apparatus, or the like. The processing unit may also be referred to as a processor, a processing board, a processing module, a processing apparatus, or the like. Optionally, a component that is in the transceiver unit 1210 and that is configured to implement a receiving function may be considered as a receiving unit, and a component that is in the transceiver unit 1210 and that is configured to implement a sending function may be considered as a sending unit. In other words, the transceiver unit 1210 includes the receiving unit and the sending unit. The transceiver unit sometimes may also be referred to as a transceiver machine, a transceiver, a transceiver circuit, or the like. The receiving unit sometimes may also be referred to as a receiver machine, a receiver, a receive circuit, or the like. The sending unit sometimes may also be referred to as a transmitter machine, a transmitter, a transmit circuit, or the like.

In a possible implementation, the transceiver unit 1210 is configured to perform a sending operation and a receiving operation of the first communication apparatus in the foregoing method embodiments, and the processing unit 1220 is configured to perform an operation other than the receiving operation and the sending operation of the first communication apparatus in the foregoing method embodiments.

For example, the processing unit 1202 is configured to perform step 201 and step 204 in FIG. 2A. The transceiver unit 1210 is configured to perform step 202, step 203, step 206, and step 202a in FIG. 2A.

In another possible implementation, the transceiver unit 1210 is configured to perform a sending operation and a receiving operation of the second communication apparatus in the foregoing method embodiments, and the processing unit 1220 is configured to perform an operation other than the receiving operation and the sending operation of the second communication apparatus in the foregoing method embodiments.

For example, the processing unit 1202 is configured to perform step 205 and step 207 in FIG. 2A. The transceiver unit 1210 is configured to perform step 202, step 203, step 206, and step 202a in FIG. 2A.

When the terminal device is a chip, the chip includes a transceiver unit and a processing unit. The transceiver unit may be an input/output circuit or a communication interface. The processing unit is a processor, a microprocessor, an integrated circuit integrated, or a logic circuit on the chip.

Refer to FIG. 13. An embodiment of this application further provides a communication system. The communication system includes the first communication apparatus shown in FIG. 8 and the second communication apparatus shown in FIG. 9. The first communication apparatus shown in FIG. 8 is for all or a part of the steps performed by the first communication apparatus in the embodiments shown in FIG. 2A, FIG. 2C, FIG. 2D, FIG. 3, FIG. 4, and FIG. 5. The second communication apparatus shown in FIG. 9 is for all or a part of the steps performed by the second communication apparatus in the embodiments shown in FIG. 2A, FIG. 2C, and FIG. 2D.

An embodiment of this application further provides a computer program product including computer instructions. When the computer program product runs on a computer, the communication methods in the embodiments shown in FIG. 2A, FIG. 2C, FIG. 2D, FIG. 3, FIG. 4, and FIG. 5 are performed.

An embodiment of this application further provides a computer-readable storage medium, including computer instructions. When the computer instructions are run on a computer, the communication methods in the embodiments shown in FIG. 2A, FIG. 2C, FIG. 2D, FIG. 3, FIG. 4, and FIG. 5 are performed.

An embodiment of this application further provides a chip apparatus, including a processor, configured to: be connected to a memory, and invoke a program stored in the memory, to cause the processor to perform the communication methods in the embodiments shown in FIG. 2A, FIG. 2C, FIG. 2D, FIG. 3, FIG. 4, and FIG. 5.

The processor mentioned in any one of the foregoing descriptions may be a general-purpose central processing unit, a microprocessor, an application-specific integrated circuit (ASIC), or one or more integrated circuits configured to control program execution of communication methods in the embodiments shown in FIG. 2A, FIG. 2C, FIG. 2D, FIG. 3, FIG. 4, and FIG. 5. The memory mentioned in any one of the foregoing may be a read-only memory (ROM), another type of static storage device that can store static information and instructions, a random access memory (RAM), or the like.

It may be clearly understood by a person skilled in the art that, for convenient and brief description, for a specific operating process of the foregoing system, apparatus, and unit, refer to a corresponding process in the foregoing method embodiments. Details are not described herein again.

In the several embodiments provided in this application, it should be understood that the disclosed system, apparatus, and method may be implemented in other manners. For example, the apparatus embodiments described above are merely examples. For example, division into the units is merely logical function division. There may be another division manner during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electrical, mechanical, or other forms.

The units described as separate parts may or may not be physically separate, and parts displayed as units may or may not be physical units, may be located in one place, or may be distributed on a plurality of network units. A part or all of the units may be selected based on an actual requirement to achieve the objectives of the solutions of embodiments.

In addition, functional units in embodiments of this application may be integrated into one processing unit, each of the units may exist alone physically, or two or more units may be integrated into one unit. The integrated unit may be implemented in a form of hardware, or may be implemented in a form of a software functional unit.

When the integrated unit is implemented in the form of the software functional unit and sold or used as an independent product, the integrated unit may be stored in a computer-readable storage medium. Based on such an understanding, the technical solutions of this application essentially, or the part contributing to a conventional technology, or all or a part of the technical solutions may be implemented in a form of a software product. The computer software product is stored in a storage medium and includes several instructions for instructing a computer device (which may be a personal computer, a server, a network device, or the like) to perform all or a part of the steps of the methods described in embodiments of this application. The foregoing storage medium includes: any medium that can store program code, such as a USB flash disk, a removable hard disk drive, a read-only memory, a random access memory, a magnetic disk, or an optical disc.

In conclusion, the foregoing embodiments are merely intended for describing the technical solutions of this application, but not for limiting this application. Although this application is described in detail with reference to the foregoing embodiments, a person of ordinary skill in the art should understand that the person may still make modifications to the technical solutions recorded in the foregoing embodiments or make equivalent replacements to a part of the technical features thereof. However, these modifications or replacements do not cause the essence of corresponding technical solutions to depart from the scope of the technical solutions in embodiments of this application.

1. A wireless communication method, wherein the method comprises:
determining, by a first communication apparatus, a first frequency domain resource, wherein frequency baselines formed by the first frequency domain resource meet a P-level redundancy distribution, and P is a positive integer; and sending, by the first communication apparatus, a sensing signal on the first frequency domain resource.

2. The method according to claim 1, wherein the P-level redundancy distribution meets a first condition and a second condition, wherein
the first condition comprises: the frequency baselines formed by the first frequency domain resource comprise a frequency baseline of a first length; and
the first length is k*length of a minimum frequency baseline, k is a positive integer belonging to [1, K], K is a ratio of a length of a maximum frequency baseline to the length of the minimum frequency baseline, and K is greater than or equal to 1; and
the second condition comprises: in the frequency baselines formed by the first frequency domain resource except largest (P−1) and smallest (P−1) frequency baselines, a quantity of redundancy distribution times is greater than or equal to P.

3. The method according to claim 1, wherein a basis of setting a value of P comprises one or more of the following: a degree of frequency-selective fading, or a frequency response amplitude difference.

4. The method according to claim 1, wherein the frequency response amplitude difference comprises at least one of the following: a ratio of a maximum value to a minimum value of α frequency response amplitude, a ratio of a variance to an average value square of the frequency response amplitude, or a ratio of a standard deviation to an amplitude response average value of the frequency response amplitude.

5. The method according to claim 1, wherein the method further comprises:
obtaining, by the first communication apparatus, a sensing requirement parameter; and
determining, by the first communication apparatus, the first frequency domain resource comprises:
determining, by the first communication apparatus, the first frequency domain resource from a frequency domain resource pool based on the sensing requirement parameter.

6. The method according to claim 1, wherein the sensing requirement parameter comprises an unambiguous ranging distance, the first frequency domain resource meets a minimum frequency baseline threshold, and the minimum frequency baseline threshold is determined based on the unambiguous ranging distance.

7. The method according to claim 1, wherein the sensing requirement parameter comprises a ranging resolution, the first frequency domain resource meets a maximum frequency baseline threshold, and the maximum frequency baseline threshold is determined based on the ranging resolution.

8. The method according to claim 1, wherein the sensing requirement parameter comprises sensing resource usage, the first frequency domain resource meets a maximum quantity N of frequency domain resources, and the maximum quantity N of frequency domain resources is determined based on the sensing resource usage.

9. The method according to claim 1, wherein the first frequency domain resource comprises a subcarrier combination, and the subcarrier combination is a combination comprising a smallest quantity of subcarriers among subcarrier combinations that meet the P-level redundancy distribution.

10. The method according to claim 1, wherein the first frequency domain resource is a frequency domain resource set formed by extracting a part of frequency domain resources from an evenly distributed frequency domain resource set.

11. The method according to claim 1, wherein
the first frequency domain resource comprises a frequency point combination obtained by shifting a frequency point combination that meets the first condition by (0, 1, 2, . . . , P−1)*|bₘᵢₙ|respectively and then obtaining a union set;

|bₘᵢₙ| is the minimum frequency baseline;
the first condition comprises: the frequency baselines formed by the first frequency domain resource comprise the frequency baseline of the first length; and
the first length is the k*length of the minimum frequency baseline, k is the positive integer belonging to [1, K], K is the ratio of the length of the maximum frequency baseline to the length of the minimum frequency baseline, and K is greater than or equal to 1.

12. The method according to claim 1, wherein the first frequency domain resource comprises: {1, 2, . . . , N1+P, 2*(N1+1), 2*(N1+1)+1, . . . , 2*(N1+1)+P−1, . . . , N2*(N1+1), N2*(N1+1)+1, . . . , N2*(N1+1)+P−1}*|bₘᵢₙ|, wherein |bₘᵢₙ| is the minimum frequency baseline, and N1 and N2 are positive integers.

13. The method according to claim 12, wherein N1, N2, and P satisfy N2*(N1+1)+P−1≥|bₘₐₓ|/|bₘᵢₙ|, and |bₘₐₓ| is the maximum frequency baseline.

14. The method according to claim 12, wherein N1, N2, and P satisfy N≥N1+P*N2, and N is the maximum quantity of frequency domain resources.

15. The method according to claim 1, wherein the method further comprises: sending, by the first communication apparatus, first information to a second communication apparatus, wherein the first information indicates a frequency domain position of the first frequency domain resource.

16. The method according to claim 15, wherein
the first information comprises a frequency domain resource construction parameter, and the frequency domain resource construction parameter is used to construct the first frequency domain resource;
the first information comprises the frequency domain position of the first frequency domain resource; or
the first information comprises a sensing quality index, and the sensing quality index indicates the frequency domain position of the first frequency domain resource.

17. The method according to claim 1, wherein the method further comprises:
sending, by the first communication apparatus, trigger signaling to the second communication apparatus, wherein the trigger signaling is used to trigger the second communication apparatus to enable a sensing function.

18. The method according to claim 1, wherein
the frequency domain resource pool comprises a frequency domain resource used for transmission of a channel state information reference signal between the first communication apparatus and the second communication apparatus; or
the frequency domain resource pool comprises a frequency domain resource used for transmission of communication data between the first communication apparatus and the second communication apparatus.

19. A wireless communication method, wherein the method comprises:
determining, by a second communication apparatus, a first frequency domain resource, wherein frequency baselines formed by the first frequency domain resource meet a P-level redundancy distribution, and P is a positive integer; and
receiving, by the second communication apparatus, a sensing signal from the first communication apparatus on the first frequency domain resource.

20. A communication apparatus, comprising a processor, and
a non-transitory computer-readable storage medium coupled to the processor and storing programming instructions for execution by the processor, the programming instructions instruct the processor to: determining a first frequency domain resource, wherein frequency baselines formed by the first frequency domain resource meet a P-level redundancy distribution, and P is a positive integer; and sending a sensing signal on the first frequency domain resource.
